(19) United States
(12) Patent Application Publication
(10) Pub. No.: US 2018/0374020 A1
(43) Pub. Date: Dec. 27, 2018

(54) TECHNIQUES MULTI-FACTOR LOCATION ANALYSIS OF RESOURCES FOR MANAGING SERVICES

(71) Applicant: Hessam Ahani, Hillsborough, CA (US)

(72) Inventor: Hessam Ahani, Hillsborough, CA (US)

(21) Appl. No.: 16/019,437

(22) Filed: Jun. 26, 2018

Related U.S. Application Data
(60) Provisional application No. 62/525,103, filed on Jun. 26, 2017.

(51) Int. Cl. G06Q 10/06; G06Q 10/10; H04W 4/02; H04W 4/12

(52) U.S. Cl. CPC G06Q 10/06314; H04W 4/12; H04W 4/025; G06Q 10/1095

(57) ABSTRACT

Techniques are disclosed to schedule a service based on multi-factor location analysis of a resource, such as a client. Upon determining that a threshold time has been reached, a resource management computer system will request a plurality of location determinants from a client device. The resource management computer system may analyze the location of the client device based on the plurality of the location determinants with respect to one or more rules indicated by a policy. The resource management computer system may communicate with a service provider system about whether the client is available to receive the service based on the location analysis.

### CROSS-REFERENCE TO RELATED APPLICATIONS

This application claims the benefit of U.S. Provisional Application No. 62/525,103, filed on Jun. 26, 2017, entitled “TECHNIQUES FOR MULTI-FACTOR LOCATION ANALYSIS OF RESOURCES FOR MANAGING SERVICES” and incorporated herein in its entirety by reference.

### BACKGROUND

Enterprises may utilize sophisticated computer systems and software to manage scheduling of their services. These enterprises may be involved in providing all types of services including health care services. A frequent challenge amongst some enterprises is optimizing the scheduling of tasks for services to maximize utilization of resources available to those enterprises. The resources may include computing resources and human resources. For services that depend on resources, scheduling services becomes more difficult based on the availability of those resources. For example, customers may not be available for services at a scheduled time, which may result in an underutilization or loss of resources. Staff of an enterprise may be busy or unavailable thereby limiting the services that can be performed. Hardware resources or supplies may be limited or unavailable for services to be rendered.

The increase in use and adoption of mobile devices by enterprises has led some to develop client-based solutions for assisting in the management and scheduling of services. Solutions may include client-based applications that may enable integration and facilitate communication by customers and their devices with the computer systems of an enterprise. Such solutions may be limited by dependence on user interaction. Some solutions may implement the use of global position system (GPS) data to determine a location of resources for establishing availability of those resources. Such solutions may be intrusive because the location may be sensitive to share. Knowing the location of resources may not provide information that indicates whether those resources are in fact available for a scheduled service and/or when those resources may be available at a destination for the service. Some have not been able to address these challenges in determining an accurate assessment of resources for providing a service.

To the extent that an enterprise can determine the availability of resources for providing a resource, an enterprise may wish to adjust scheduling to utilize resources at any given time. This may include changing schedules to times when resources are available, or when services can be performed within available times. Enterprises are unable to communicate effectively with resources to determine if and when they may become available. Enterprises can benefit from new techniques for determining a location of resources for scheduling services.

### SUMMARY

Techniques are disclosed for multi-factor location analysis of resources. Multi-factor location analysis of resources (e.g., a customer, a service provider, and equipment for providing services) may be useful for determining availability of resources for managing the scheduling of a service. In certain embodiments, techniques may be implemented by a resource management computer system. The availability of a resource may include whether the resource is available, when the resource will be available, and when the resource may arrive at a destination. The resource management system can facilitate communication with multiple client devices about the availability of a resource based on multi-factor location analysis. The communication with multiple client devices can be performed to determine whether other resources accessible by different client devices can be utilized for a service.

Multi-factor location analysis enables the service provider system to assess the availability of a resource at a particular time based on the resource's current location. In such cases, resources are not wasted as commonly seen in hospitals, governmental agencies, utility companies, and social benefit facilities, where a resource (i.e., client/customer) makes an appointment to receive a service, but is unable to arrive at the appointment on time for reasons such as traffic jams or miscellaneous urgent business or personal matters. In such instances, the service provider has no indication besides the rare instances in which the client calls the service provider to cancel the appointment. Embodiments disclosed herein enable the service provider to reallocate the resources to other clients/customers if a client/customer can not show up for an appointment. Based on embodiments disclosed herein, the service provider may have an indication regarding the availability of the resource at a certain time prior to the appointment. The service provider may interact with the client/customer when it is determined that the client/customer will not make the appointment and reschedule the appointment. At the same time the resources allocated to serve the client/customer that will not show up can be reallocated to serve another client/customer nearby or on the waitlist. With the multi-factor location analysis of the present disclosure, the service provider can improve its resource efficiency and optimize resource allocation.

The resource management system can implement multi-factor location analysis of client devices. Each client device may be associated with a different resource. The location analysis of any given client device may be useful for determining analyzing a location of a resource associated with that client device. The location analysis determined for a resource may include a physical location of the resource, whether the resource may arrive to a destination where a service dependent on the resource is provided, a direction of travel of the resource, and/or other information about or based on a location of the client device. The multi-factor location analysis may be implemented based on one or more location determinants. Each location determinant may be selected based on the location analysis to be determined for scheduling a service. A location determinant may be defined based on one or more attributes. Location determinants for a client device may be determined by the resource management system, the client device, or a combination thereof. Location determinants may include information that may be useful for determining a relative location of a client device with respect to a destination. Location determinants may include, without limitation, global positioning system (GPS) coordinates, movement attributes (e.g., speed, direction), mode of movement (e.g., automobile, motorcycle, or boat), traffic information, calendar schedule, and use of functions on a client device.

In some embodiments, the resource management system may determine location analysis of a client device irrespective of a service for a user associated with the client device. For example, the resource management system may perform location analysis of client devices anonymously without a request from a service provider. In at least one embodiment, the resource management system operates as a third party system or an intermediary system that provides location analysis information upon request by a registered recipient. The resource management system may perform location analysis periodically according to a schedule. The resource management system may monitor and manage location analysis for one or more users, or an entity. In some embodiments, the resource management system may operate as an intermediary system that can implement security measures for the determination and management of location analysis information for one or more users. The user(s) may be part of a group (e.g., tenant). Location analysis may be managed with or without knowledge of the user(s). Location analysis may be monitored based on registration of the user(s) with the resource management system. The location analysis information may be provided to one or more service provider systems based on authorization by the user(s) for which the information is determined. In some embodiments, location analysis information for a user may be determined based on one or more preferences of the user. The location analysis may be specific based on the type of the information the resource management system is permitted to obtain and determine for the user with respect to his/her registration.

Multi-factor location analysis may be implemented based on one or more rules driven by a policy provided by a service provider system of a service provider. Location determinants may be chosen based on the rules for a policy. The resource management system provides location analysis information to service provider systems to enable the service provider system to provide updates to the service provider. The resource management system may facilitate communication between client devices of resources and service providers for scheduling services and/or notifying parties about a service. The resource management system may perform operations for managing resources for scheduled services based on the policy and instructions from a service provider. An application may be provided with graphical interfaces that facilitate display of information and management of services provided by a service provider system.

Some embodiments may be implemented by a computing system that is configured to implement methods and operations described herein. Yet some embodiments relate to systems, computer products, and machine-readable tangible storage media which employ or store instructions for methods and operations described herein. Systems may include one or more processors and memory. Systems may include a computer product, machine-readable tangible storage media, modules, or a combination thereof to perform methods and operations described herein.

The foregoing, together with other features and embodiments will become more apparent upon referring to the following specifications, claims, and accompanying drawings.

### BRIEF DESCRIPTION OF THE DRAWINGS

Illustrative embodiments of the present disclosure are described in detail below with reference to the following drawing figures:

FIG. 1 shows a high-level block diagram illustrating a service management system according to an embodiment.

FIG. 2 illustrates a flow chart for implementing a process for multi-factor location analysis of a resource for managing scheduling of a service according to some embodiments.

FIG. 3 illustrates a sequence diagram of a process for multi-factor location analysis of resources for managing scheduling of a service according to some embodiments.

FIG. 4 illustrates an example of a graphical interface on a resource management computer system according to some embodiments.

FIG. 5 shows an example application of the graphical interface on the resource management computer system according to some embodiments.

FIG. 6A-6D show an example application of a graphical interface on a client device according to some embodiments.

FIGS. 7-8 illustrate flowcharts of processes for multi-factor location analysis of a resource for managing scheduling of a service according to an embodiment.

FIG. 9 shows a simplified block diagram of a computing system according to certain embodiments.

### DETAILED DESCRIPTION

In the following description, for the purposes of explanation, specific details are set forth in order to provide a thorough understanding of embodiments of the disclosure. However, it will be apparent that various embodiments may be practiced without these specific details. For example, circuits, systems, algorithms, structures, techniques, networks, processes, and other components may be shown as components in block diagram form in order not to obscure the embodiments in unnecessary detail. The figures and description are not intended to be restrictive. The foregoing, together with other features and embodiments will become more apparent upon referring to the following specification, claims, and accompanying drawings.

Some embodiments may be implemented by a computer system that is configured to implement methods and operations disclosed herein. Yet some embodiments relate to systems, computer products, and machine-readable tangible storage media, which employ or store instructions for methods and operations disclosed herein. In at least one embodiment, systems may include one or more processors and memory. The memory may store instructions that are executable by the one or more processors to perform methods and operations disclosed herein. Systems may include a computer product, machine-readable tangible storage media, modules, or a combination thereof to perform methods and operations disclosed herein.

The some embodiments, such as those disclosed with respect to the figures, may be described as a process which is depicted as a flowchart, a flow diagram, a data flow diagram, a structure diagram, a sequence diagram, or a block diagram. Although a sequence diagram or a flowchart may describe the operations as a sequential process, many of the operations may be performed in parallel or concurrently. In addition, the order of the operations may be re-arranged. A process is terminated when its operations are completed, but could have additional steps not included in a figure. A process may correspond to a method, a function, a procedure, a subroutine, a subprogram, etc. When a process corresponds to a function, its termination may correspond to a return of the function to the calling function or the main function.

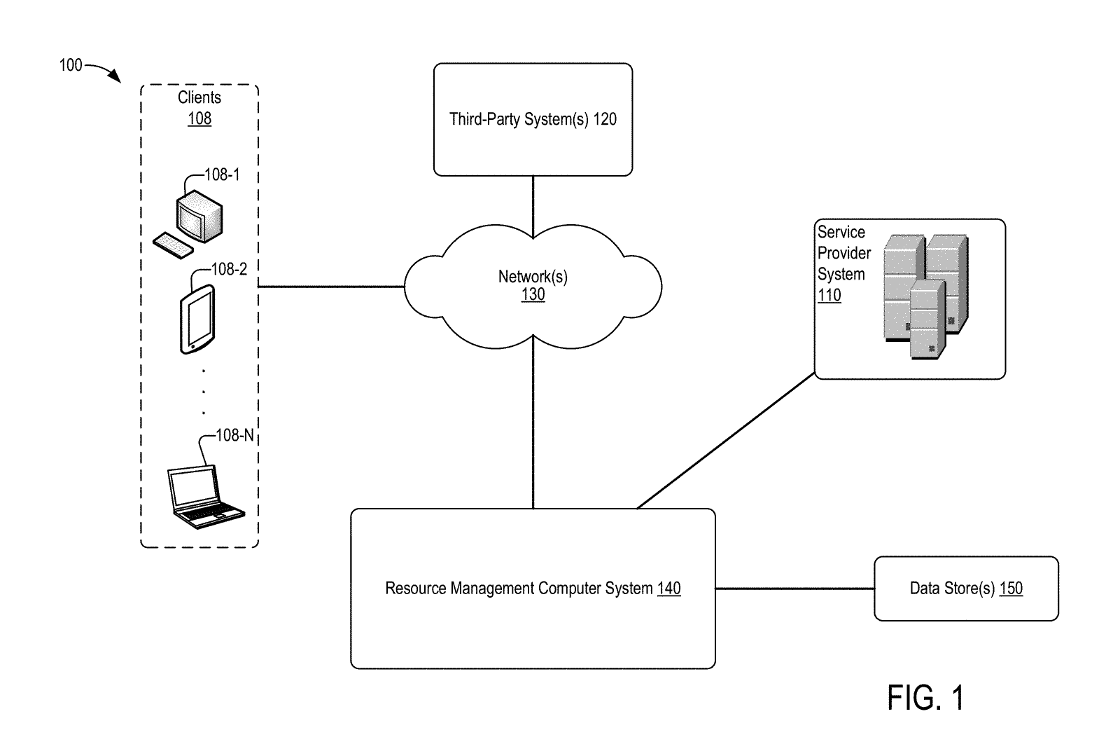

The processes disclosed herein may be implemented in software (e.g., code, instructions, program) executed by one or more processing units (e.g., processors cores), hardware, or combinations thereof. The software may be stored in a memory (e.g., on a memory device, on a non-transitory computer-readable storage medium). In some embodiments, the processes depicted in flowcharts herein can be implemented in the system of FIG. 1. The particular series of processing steps in this disclosure are not intended to be limiting. Other sequences of steps may also be performed according to alternative embodiments. For example, alternative embodiments of the present disclosure may perform the steps outlined above in a different order. Moreover, the individual steps illustrated in the figures may include multiple sub-steps that may be performed in various sequences as appropriate to the individual step. Furthermore, additional steps may be added or removed depending on the particular applications. One of ordinary skill in the art would recognize many variations, modifications, and alternatives.

In an aspect of some embodiments, each process disclosed herein can be performed by one or more processing units. A processing unit may include one or more processors, including single core or multicore processors, one or more cores of processors, or combinations thereof. In some embodiments, a processing unit can include one or more special purpose co-processors such as graphics processors, digital signal processors (DSPs), or the like. In some embodiments, some or all of processing units can be implemented using customized circuits, such as application specific integrated circuits (ASICs), or field programmable gate arrays (FPGAs).

### I. Service Management System

FIG. 1 shows a high-level block diagram of a system (“Service Management System”) 100 according to an embodiment of the present disclosure. One or more of the below-described techniques may be implemented in or involve one or more computer systems. The computing environment in FIG. 1 is not intended to suggest any limitation as to scope of use or functionality of described embodiments.

System 100 may include one or more server provider systems 110, each of which can provide or support providing one or more services to people (e.g., customers). Examples of services include, without limitation, health care services, technology services, legal services, personal care services, fitness services, dining services, entertainment services, or consumer services. A service may be provided based on one or more resources. Service provider system 110 may manage and/or obtain access to the resource(s) for providing a service. Resources may be obtained from one or more third-party systems 120 included in system 100. Resources may include, without limitation, people, materials, computer resources (e.g., hardware, software, or middleware), and/or places. People may include customers that receive services and people that provide services (e.g., service members or providers). For example, people may include employees or staff members working for the service provider. Services may be provided via an application accessible using a device (e.g., a client device). Service provide system 110 may provide a service to a customer according to a schedule that may be dependent on resources and/or a schedule for services provided to other customers.

A challenge faced by many service providers is the ability to determine an availability of resources for providing a service. Specifically, service provider systems may be limited or unable to estimate or assess if and when a resource will arrive to a destination of a service provider where a service will be provided. Some service providers may attempt to communicate with a device associated with a resource to determine a location of a resource. For example, a service provider communicates with a mobile device of a customer to determine whether the customer will arrive for an appointment. Often times, a service provider may not receive notification that a resource will not be available until shortly before or at a scheduled time for the service. For example, a doctor may not notify his office (e.g., a service provider) that he will not be available at a scheduled time. These examples are merely illustrative to disclose some embodiments of the present disclosure and thus, are not intended to be limited to the disclosed examples.

Service providers may struggle with ways to accurately assess if and when a resource will arrive at a location. The resources may include people involved with a service as well as devices and/or equipment used to provide a service. Multi-factor location-based analysis information may be useful to enable the service provider to determine scheduling based on availability of resources including a person that may receive a service. The service provider may wish to communicate in real-time with a device associated with a resource to provide notifications and/or options for adjusting scheduling. The service provider may wish to communicate with other devices to determine whether a resource can be replaced or substituted. These challenges occur, in part, due to disparate computer systems between these parties, such that the computer systems are unable to efficiently and effectively communicate about availability of resources. The limitations with communication increase the difficulty for service providers to obtain real-time information about resources, including staff and customers, for services. As a result, service providers and customers may expend computing resources to facilitate communication and exchange of information for services. Their efforts are far from efficient and may not result in an accurate, real-time assessment of location of resources for services. Due to the lack of computing infrastructure for communication, users may not be able to accurately and efficiently communicate about scheduling of services based on relative location of resources.

To solve these and other challenges in managing resources for service provider systems, techniques disclosed herein include a resource management computer system 140 (also referred to herein as “resource management system”). Resource management system 140 can be implemented in or with any service provider systems, such as service provider system 110. Resource management system 140 can improve efficiency of computing resources used by service provider systems to assess availability of resources. Specifically, resource management system 140 may reduce use of computing resources by facilitating communication with clients (e.g., devices) associated with resources. System 100 may include one or more client systems 108-1, 108-2, . . . 108-N (collectively clients 108), where each is referred to herein as a “client system” or “client”. A client may be operated by one or more users, such as a customer or a person (e.g., service person) associated with a service provider for providing a service. A client may be operated by or associated with a resource, such as a device or a physical resource, which can be tracked based on a device associated with the resource. Resource management system 140 can facilitate communication with clients to perform multi-factor location analysis to assess availability of a resource based on a relative location of a client. Resource management system 140 may determine and manage (e.g., create, read, update, delete, and store) information based on location analysis (referred to herein as “location analysis information”) for users.

The location analysis may be based on one or more location determinants. The location analysis may include consideration of non-location based determinants that collectively can be used to for location-based analysis to assess a position of movement of a device for purposes of assessing if and when a resource may be available. Location analysis may perform location analysis to determine a location assessment for a user. The location assessments may vary in degree of accuracy of location of a user with respect to a client device of the user. An “absolute location” of a user may be determined based on location determinants that provide an absolute or near absolute location of a user based on a client device of the user. Location determinants for an absolute location may include, for example, a GPS location of the client device. A “relative location” of a user may be determined based on a location of a user in relation to other person(s), place(s), and/or thing(s). A relative location may be less precise than an absolute location. A relative location may be useful in estimating a time for arriving at a time to obtain a service. An “approximate location” may be less precise than an absolute location. An approximate location may indicate an “approximate” location of a user, such as a city or county where the user is located.

The location assessment in the location analysis information may be determined based on use of the location analysis information. Users of the location analysis information may be based on the service that requests the information. Each service may be provided or implemented using an application. The location analysis information may be used for different purposes, which may demand an assessment of the location of a client device with respect to a particular degree of accuracy. For example, an approximate location may be useful to determine whether a user can partake or receive a service. An absolute location may be useful for a service which depends on the physical presence of a user to receive or utilize the service.

In some embodiments, location analysis information may include multiple assessments of location including different assessments of location, such as absolute location, relative location, and approximate location. A location of a user based on a client device may be based on multi-factor location analysis including different assessments of location and other location determinants (e.g., direction of travel, speed of travel, and mode of travel). Location analysis information may include and/or consider location history based on historical location information determined by resource management system 140 and/or obtained from other third party providers or services.

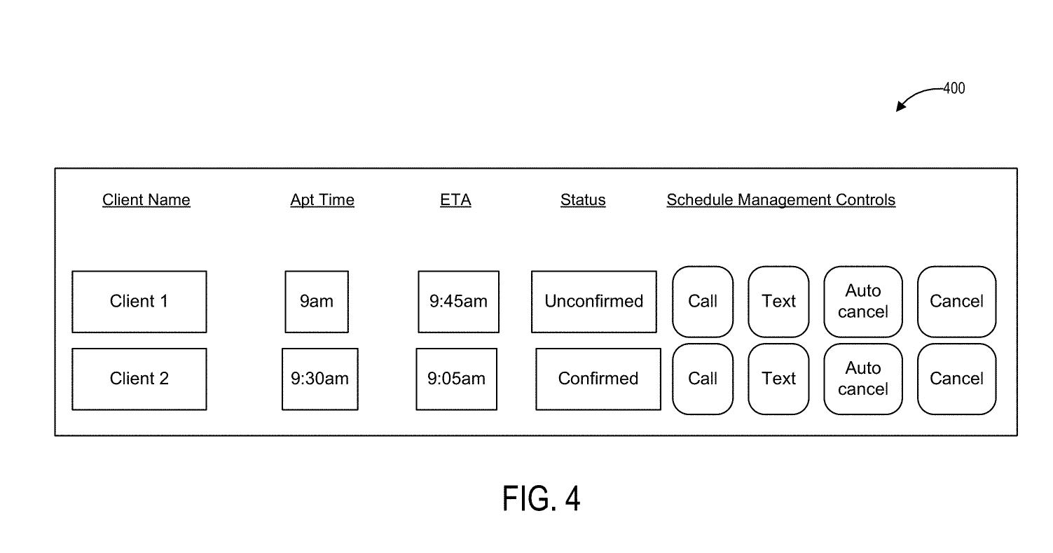

In some embodiments, resource management system 140 performs operations for managing resources and scheduling of services for the service provider system. For example, resource management system 140 can determine adjustments to scheduling of a service based on multi-factor location analysis of one or more clients associated with resource(s) to provide the service. Resource management system 140 may perform processing and/or provide information to a service provider system for determining a schedule for a resource. Resource management system 140 may adjust a schedule for a resource and/or provide options for scheduling based on location analysis of the resource. In some embodiments, other clients may be provided with options for scheduling availability or changes based on a multi-factor location analysis of a resource. Resource management system 140 may provide a graphical interface (e.g., a visual dashboard) of information for scheduling of services based on resources, including an estimated schedule for a resource based on multi-factor location analysis. Examples of interfaces are illustrated and described with reference to FIG. 4.

In some embodiments, resource management system 140 may provide a service (e.g., a location analysis service) for location analysis. The service may include managing location analysis including security of the location analysis. Location analysis information for a user may be provided to one or more service providers based on authorization of the user. The authorization of a user may extend to the type of information gathered or determined about the user and/or the degree to which location analysis is performed with respect to each service provider permitted to obtain the location analysis information. Resource management system 140 can manage security of location analysis including how information is obtained, determined, shared, and stored. A user may configure an account for registration to permit different levels of security and/or access for location analysis. The registration may be configured differently with respect to each service provider for which resource management system 140 communicates for the user. Location analysis may be performed for one or more users, including a group of users (e.g., a tenant), and/or an entity. Location analysis may be provided to a user based on registration of the user. Users may receive a service as a group, such as a tenancy of multiple tenants. Registration may include providing information for an account of the user(s), including one or more client devices registered for location analysis, and/or settings (e.g., security and access) for managing location analysis. Settings and location analysis may be managed with respect to each user, and/or each service provider for which location analysis is performed with respect to the user. In this manner, a user can be reassured that security of location information is managed properly in a secure, central system with respect to each service provider.

In certain embodiments, clients may provide one or more graphical interfaces in an application (e.g., an “app”) for interaction with a service provider. Among the many functions provided by an app, the app can enable a user to view a schedule for services and any changes to the schedule based on multi-factor location analysis. The app may facilitate communication by a user about a resource associated with the device to a service provider. The app may provide one or more schedule options (e.g., alternatives) for scheduling determined by resource management system 140 based on availability of resources for a service using multi-factor location analysis. The app may provide additional information (e.g., supplementary information about the service or a notification of status) about a service before, during, and/or after the service.

Resource management system 140 may provide one or more graphical interfaces in an application. The graphical interfaces may include those provided at a client. The app may enable a user of a service provider to manage resources and scheduling for services. The app may be accessible by a client. The app may indicate schedules for services including information about availability of resources for a service, including an estimated time for the resource(s). The app may provide a graphical display of a current status and/or changes to a status of a schedule for any service. The app may display scheduling options provided to clients for resources. The app may display scheduling availability and/or limitations based on multi-factor location analysis of resources for each schedule of a service. The app may be interactive to enable a user of a service provider to view and/or manage scheduling for services. In some embodiments, the app may provide a visual display of any features including a status indication of a location of each resource, whether that resource is on-time or late, and/or when the resource is present for service. The app may provide suggestions for scheduling based on multi-factor location analysis.

Clients 108 may be implemented in or as a device. Devices for clients may be of various different types, including, but not limited to, endpoint devices, a wearable device (e.g., a smart watch), a consumer device (e.g., an appliance), personal computers, desktops, server computers, server clusters, distributed servers, Internet of Things (TOT) devices, mobile or handheld devices such as a laptop, a mobile phone, a tablet, computer terminals, etc., and other types of devices. In some embodiments, each of clients 108 may be implemented as an application hosted on a computing device (e.g., a mobile device or a computer). In some embodiments, a remote device may be an endpoint, such as a workspace, that is running on another device. Clients 108 may be operated by different users including customers, service providers, and resource providers. A client may be associated with, implemented in, or affixed to a resource. The client may be configured to implement operations disclosed herein with respect to a client.

In some embodiments, clients 108, resource management system 140, service provider system 110, and third party system 120 may be communicatively connected via one or more communication networks 130. Examples of communication networks include, without restriction, the Internet, a wide area network (WAN), a local arear network (LAN), an Ethernet network, a public or private network, a wired network, a wireless network, and the like, and combinations thereof. Different communication protocols may be used to facilitate the communications including both wired and wireless protocols such as IEEE 802.XX suite of protocols, TCP/IP, IPX, SAN, AppleTalk, Bluetooth®, and other protocols. Communication between clients 108 and service provider systems may be facilitated by communication via resource management system 140. Such communication may include messages, such as responses and requests. Resource management system 140 may generate data to facilitate communication. The communication, although described by examples herein, may not be limited to such examples, and may use a variety of types of communication and services supported by clients 108 and service management systems.

Clients 108 may each implement a communication interface, such as a communication interface that includes functional blocks or modules, each of which may be configured to handle communications with resource management system 140. In some embodiments, a communication interface may be implemented as other interfaces, such as a network interface, web interface, or other remote communication interface, to enable an app to communicate with resource management system 140.

Client 108 may provide one or more interfaces, such as a physical interface, a graphical interface (e.g., a graphical user interface), or a combination thereof. A graphical interface of interface may be generated by a device, received from resource management system 140, or a combination thereof. The graphical interface may be updated or modified by a device or received from resource management system 140 in response to interaction with the interface. Examples of graphical interfaces are disclosed herein with reference to the embodiments described in this disclosure. The interface may be provided by resource management system 140 via network 130 as part of a service (e.g., a cloud service or a web service) or application. In some embodiments, clients 108 may provide access to one or more applications (“app”). Apps may enable a user to access and perform services provided by resource management system 140.

Each of resource management system 140 and service provider system 110 may be implemented using a computer system, which may comprise one or more computers and/or servers which may be general purpose computers, specialized server computers (including, by way of example, PC servers, UNIX servers, mid-range servers, mainframe computers, rack-mounted servers, etc.), server farms, server clusters, distributed servers, or any other appropriate arrangement and/or combination thereof. The computer system may implement any of operating systems or a variety of additional server applications and/or mid-tier applications, including HTTP servers, FTP servers, CGI servers, Java servers, database servers, and the like. Exemplary database servers include without limitation those commercially available from Microsoft, and the like. In various embodiments, resource management system 140 may be configured to run one or more services or software applications described in the foregoing disclosure. Resource management system 140 may correspond to a computing system for performing processing as disclosed herein according to an embodiment of the present disclosure.

In some embodiments, resource management system 140 may be implemented as an enterprise computing system or a cloud computing system comprising one or more computers and/or servers that may include those described above. Such implementations may facilitate communication between clients 108 and service provider systems as a service. By providing a service as cloud computing system, clients 108 and service provider systems can reduce use of computing resources, and instead rely on computing resources of resource management system 140 to facilitate communication. Clients 108 can be implemented in a lightweight manner using resources for communication with resource management system 140 and to provide access to interfaces provided by resource management system 140. Each of clients 108 and resource management system 140 may include several subsystems and/or modules. Resource management system 140 may have more or fewer subsystems and/or modules, may combine two or more subsystems and/or modules, or may have a different configuration or arrangement of subsystems and/or modules. Subsystems and modules of resource management system 140 may be implemented in software (e.g., program code, instructions executable by a processor), firmware, hardware, or combinations thereof. In some embodiments, the software may be stored in a memory (e.g., a non-transitory computer-readable medium), on a memory device, or some other physical memory and may be executed by one or more processing units (e.g., one or more processors, one or more processor cores, one or more GPUs, etc.). In some embodiments, resource management system 140 may be implemented in or with a service provider system. In some embodiments, resource management system 140 and/or apps for resource management system 140 may be implemented by third-party system 120.

Each of clients 108, resource management system 140, third-party system 120, and service provider system 110 may include at least one memory, one or more processing units (or processor(s)), and storage. The processing unit(s) may be implemented as appropriate in hardware, computer-executable instructions, firmware, or combinations thereof. Computer-executable instructions or firmware implementations of the processing unit(s) may include computer-executable or machine-executable instructions written in any suitable programming language to perform the various operations, functions, methods, and/or processes disclosed herein. The memory in any of the systems in FIG. 1 may store program instructions that are loadable and executable on the processing unit(s), as well as data generated during the execution of these programs. The memory may be volatile (such as random access memory (RAM)) and/or non-volatile (such as read-only memory (ROM), flash memory, etc.). The memory may be implemented using any type of persistent storage device, such as computer-readable storage media. In some embodiments, computer-readable storage media may be configured to protect a computer from an electronic communication containing malicious code. The computer-readable storage media may include instructions stored thereon, that when executed on a processor, perform the operations disclosed herein.

In certain embodiments, each of clients 108 and resource management system 140 may also provide other services or software applications that can include non-virtual and virtual environments. In some embodiments, these services may be offered as web-based or cloud services or under Software as a Service (SaaS) model to the users of clients 108. The services offered by resource management system 140 may include application services. Application services may be provided by resource management system 140 via a SaaS platform. The SaaS platform may be configured to provide services that fall under the SaaS category. The SaaS platform may manage and control the underlying software and infrastructure for providing the SaaS services. By utilizing the services provided by the SaaS platform, customers can utilize applications executing in resource management system 140, which may be implemented as a cloud infrastructure system. Users can acquire the application services without the need for customers to purchase separate licenses and support. Various different SaaS services may be provided. Users operating clients 108 may in turn utilize one or more applications to interact with resource management system 140 to utilize the services provided by subsystems and/or modules of resource management system 140.

System 100 may also include or be coupled to additional storage, which may be implemented using any type of persistent storage device, such as a memory storage device or other non-transitory computer-readable storage medium. In some embodiments, local storage may include or implement one or more databases (e.g., a document database, a relational database, or other type of database), one or more file stores, one or more file systems, or combinations thereof. For example, system 100 may be coupled to or may include one or more data stores 150 (referred to herein as “data stores”). The memory and the additional storage are all examples of computer-readable storage media. For example, computer-readable storage media may include volatile or non-volatile, removable or non-removable media implemented in any method or technology for storage of information such as computer-readable instructions, data structures, program modules, or other data. The data stores 150 may be accessible by or implemented in resource management system 140.

In some embodiments, resource management system 140 may communicate with one or more third-party system(s) 120. The communication may be to obtain information for location services provided for location analysis. Such information may include traffic information.

### II. Processes for Multi-factor Location Analysis of Clients for Service Management

Processes disclosed herein relate to processes for resource management, in particular multi-factor location based analysis for assessing resources availability for scheduling services. Processes may be implemented using one or more interfaces. Examples of interfaces are shown with reference to interfaces in this disclosure, any of which may be implemented to enable processes disclosed herein.

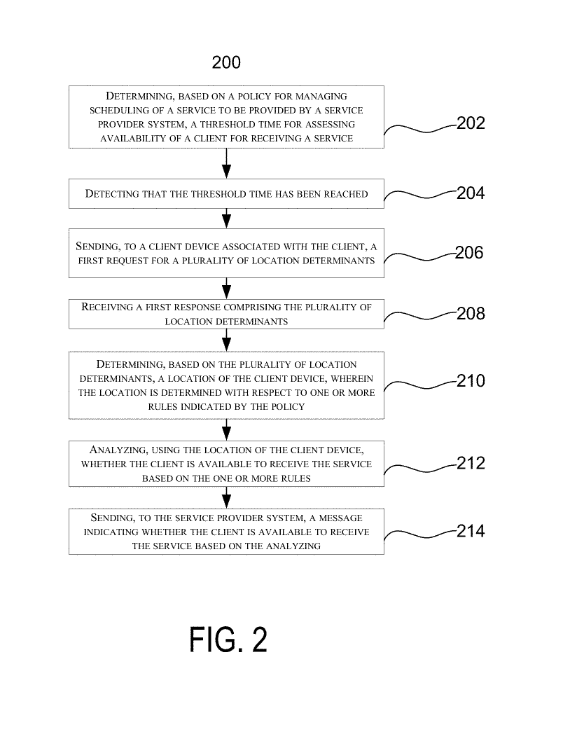

FIG. 2 illustrates a flow chart to implement certain embodiments of the present disclosure. A service scheduling process 200 based on multi-factor location analysis according to certain embodiments of the present disclosure may be performed by the resource management computer system 140 as shown in FIG. 1. In certain embodiments, the service management computer system 140 may also be referred to as a server or a computing sever.

At step 202, the resource management computer system 140 may determine a threshold time for assessing availability of a client for receiving a service. For example, the threshold time may be 2 hours before an appointment. In certain embodiments, the threshold time may be determined based on a policy for managing scheduling of a service to be provided by the service provider system 110.

At step 204, the resource management computer system 140 may detect that the threshold time has been reached or exceeded. However, even prior to the threshold time being reached, in certain embodiments, the resource management computer system 140 may push (i.e., send) a notice or reminder to a client device. Such notices and/or reminders may be pushed periodically.

At step 206, based on detecting that the threshold time has been reached, the resource management computer system 140 may send to a client device associated with a client 108 a request for a plurality of location determinants. In certain embodiments, the request may be sent through the network 130.

At step 208, the resource management computer system 140 may receive from the client device associated with the client a response comprising the plurality of location determinants. In certain embodiments, the plurality of location determinants may be received through the network 130. In some embodiments, the plurality of location determinants may be received separately in respective plurality of responses. In some embodiments, the resource management computer system 140 may receive from the client device updated location determinants periodically with or without sending another request.

At step 210, the resource management computer system 140 may determine, based on the plurality of location determinants, a location of the client device associated with the client 108, wherein the location is determined with respect to one or more rules indicated by the policy. In certain embodiments, the rules indicated by the policy may be a predetermined distance to the destination for providing the service, such as a hospital. For example, the distance may be set to 25 miles from the hospital. In certain embodiments, the location may be determined based on connecting to a particular access point, such as a WiFi access point or a bluetooth transmitter.

At step 212, the resource management computer system 140 may analyze, using the location of the client device associated with the client 108, whether the client is available to receive the service based on the one or more rules. For example, if the location of the client is less than 25 miles away from the hospital, and the client is driving, the resource management computer system 140 may determine that the client is available to receive the service. In the other case, if the client is more than 25 mile away from the hospital, and the client is walking, the resource management computer system 140 may determine that the client is not available to receive the service.

At step 214, the resource management computer system 140 may send, to the service provider system 110, a message indicating whether the client is available to receive the service based on the analyzing of step 212. In certain embodiments, the message may include the estimated time of arrival of the clients, movement status of the client, and the distance of the client to the service provider system 110.

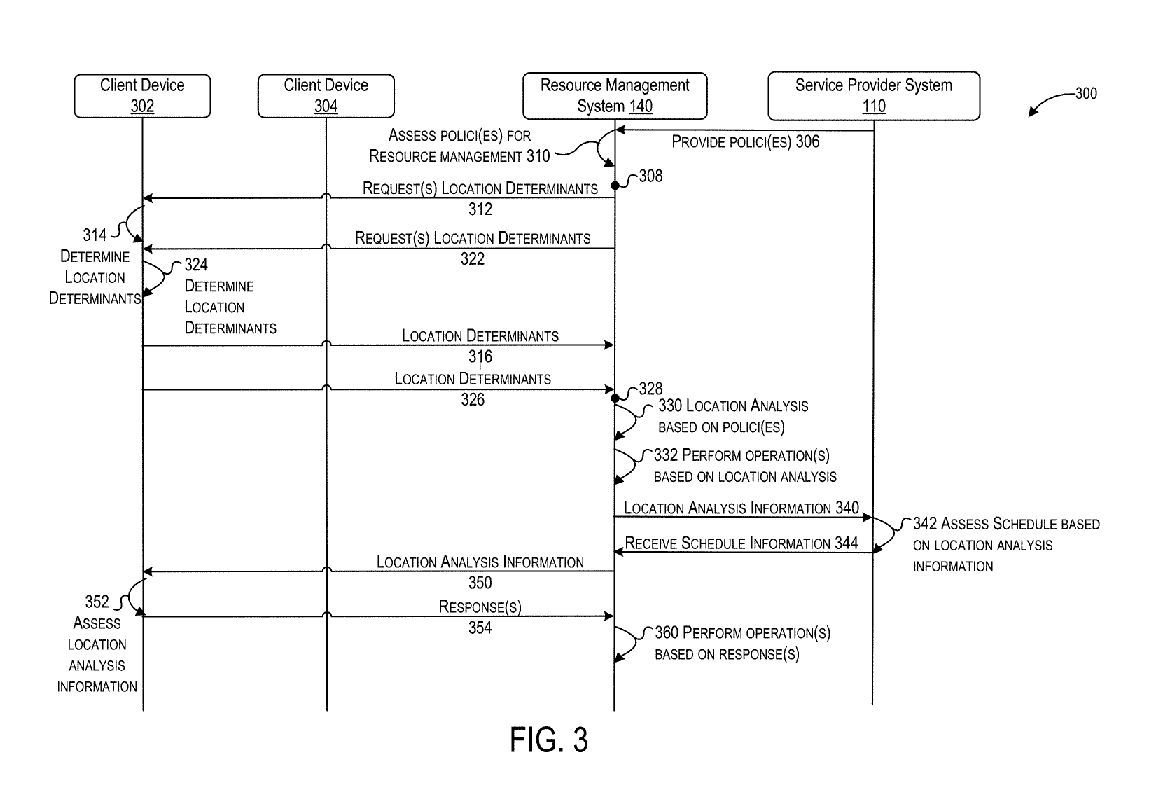

Detailed explanation of the aspects of the embodiments of the present disclosure is illustrated below with respect to FIG. 3 to FIG. 9.

FIG. 3 illustrates a sequence diagram of a process 300 for assessing scheduling of a service based on a multi-factor location analysis of a resource for the service. A resource may include any person or object involved in a service. For example, a resource may include a person who is scheduled to receive a service. Often times, a service provider system is unable to determine whether a person is available or likely to be available to receive a service. A service provider system may be unable to determine whether equipment and devices within a service provider system are available. The availability of a resource impacts a service provider to provide services and disrupts the efficiency of the service provider's system results in loss of resources, time, and money. Process 300 illustrates how multi-factor location analysis may be implemented to determine a more accurate location of a client associated with a resource. The location may be used to determine whether the resource is available and if so, when the resource may arrive at a destination location for a service that is scheduled.

In some embodiments, process 300 may be implemented by a sequence of steps performed according to a combination of steps in FIG. 3. The process may be implemented by one or more elements of system 100.

At step 306, a service provider system (e.g., service provider system 110) may provide one or more policies for managing scheduling of services. Process 300 may be initiated at step 306. A service provider associated with the service provider system may define the polici(es) according to the criteria for scheduling services.

A policy may include one or more rules for determining how to assess a schedule for a service. The rules may define resource availability, which is used for location analysis of location determinants for resources. Resource availability may be defined based on one or more thresholds. Each service may depend on resources including the people providing the service and the person receiving a service. A policy may define one or more rules for assessing availability of a resource. For example, a policy may define a rule for assessing resources for a service upon a threshold time period before the service is scheduled. The rule(s) may indicate a time period when to assess a schedule. For example, the time period may have a start time at 308 and end time at 328. The time period may be a specific range of time or may be periodic according to a schedule. For example, a rule indicates a time period of 2 hours before a scheduled service when availability of resources is to be assessed. In another example, a rule indicates a distance based on when to assess arrival of a resource for a scheduled service. In this example, the distance may be defined within proximity to an office where the service is to be rendered so that the service provider system can coordinate resources for arrival of the resource. In other words, the rule may be defined to determine proximity threshold for the location of a customer to check-in for a service before arriving for the service. As used in the present disclosure, “check in” may describe a final confirmation of a client to receive a service. One or more clients may be communicated with to assess resource availability for scheduling a service. A schedule may be assessed based on such communications, collectively or individually with respect to each resource. The rule(s) may indicate the conditions for which to assess the schedule, including accuracy at which to determine whether the schedule will be satisfied. One or more location determinants may be requested based on the rule.

In some embodiments, the rule(s) may indicate the location determinants to consider for assessing availability of a resource for a scheduled service. Each rule may be defined based on location determinants to be considered for a time period. Location determinants for rules may vary. A client may be configured to determine a subset of possible location determinants. Each location determinant may be defined based on or more attributes defining a rule. Multi-factor location analysis may be performed based on the policy using the location determinants. The attributes for determining the location determinants may be permitted for access based on the access permitted by a user through the application. A user may register with a service provider system. The user may register via the app on a client to indicate the level of consent to access information on the client.

At step 310, resource management system 140 may implement one or more graphical interfaces, such as the graphical interface of FIG. 4 which illustrates a graphical interface (e.g., a dashboard) for management of services. At step 310, a policy for resource management may be assessed to determine whether to communicate with any clients to assess availability of resources for one or more services. Process 300 may be implemented to determine whether a schedule for a service will be satisfied as scheduled. Process 300 may be initiated for assessment of a policy for determining availability of a resource for a service that is scheduled. In some embodiments, process 300 may initiated by interaction with the graphical interface. For example, a user operating service management system 110 may interact with the graphical interface to request availability of resources for a service, such as the availability of a customer.

In at least one embodiment, resource management system 140 may request clients for data about multiple location determinants. For example, resource management system 140 may request location determinants 312 from client device 302. Client device 302 may be associated with a customer who is scheduled to receive a service. Resource management system 140 may request location determinants 322 from client device 304. Client device 304 may be associated with a person that provides the service for a service provider. Each of client devices 302, 304 may be any one of clients 108 in FIG. 1.

Each of request 312, 322 may be for one or more different location determinants. The location determinant may be requested based on the rule(s). Rules may be defined for different resources. In some embodiments, scheduling for a service may be assessed based on consideration of location determinants from one or more resources. In one example, location determinants from a client device of a service person may be considered for assessing a schedule when the service person is to be at a destination to assist with providing a service. In this example, the location determinants for a client device of a customer may be considered separately to assess a schedule of when the customer may arrive at a location to receive a service. The availability of multiple resources, such as a customer and a service person may impact a schedule of when a service can be provided to the customer. As such, in some embodiments, location determinants may be obtained for multiple resources to determine scheduling for a service based on location determinants for multiple resources. Location determinants may be requested based on a type of resource for which certain location determinants are obtainable.

In some embodiments, multiple requests for location determinants may be sent to each of client devices 302, 304. Multiple requests may be sent according to a periodic schedule. Requests may be sent within a time period (e.g., the time period starting at 308 and ending at 328) when to assess availability of a resource. Multiple requests for location determinants may be sent for location analysis over a time period. Location analysis may include determining whether a resource is traveling in a particular direction. The direction of travel is one type of location determinant that may be based on one or more attributes.

At each of steps 314 and 324, location determinants may be obtained based on the request 312 and request 322, respectively. Examples of location determinants may include, without limitation, location coordinates, application usage, connectivity information for one or more communication connections to a device, device movement, calendar information, and other information related to operation of the device. Location determinants may include other determinants that may be useful for determining use, location, and/or movement of a device. These types of determinants, collectively, may be useful in determining that a client device is in possession or coupled to a resource, and if so, where a resource is located and/or moving based on multi-factor location analysis using the client device.

In some embodiments, each of steps 314 and 324 may be implemented in response to interaction with a graphical interface at each of client device 302 and client device 304, respectively. A graphical interface in an application may prompt or enable a user to initiate a process for determining availability of a resource (e.g., a user of either of the client device 302 or client device 304) for a scheduled service.

Location determinants may be obtained using one or more methods known to a person of ordinary skill in the art. The following is a non-exhaustive list of location determinants, which are not mentioned in any particular order of priority. The number and order in which location determinants are determined may vary. A first location determinant is GPS coordinates of the device or a location close to the device. A device's hardware (e.g., a GPS system) may be used to obtain GPS coordinates of the device or a location (e.g., a nearest communication network or system). A second location determinant is movement data about the device. Movement data may be obtained from hardware on the device, such as a gyroscope, which may indicate an occurrence of a movement of the device. Movement data may include data indicating whether the device is moving or has moved, and/or a rate of movement. A third location determinant is application usage that indicates whether an application was used, and if so, when the application was last used. Application usage may be determined based on data stored on a device indicating when an application was last accessed (e.g., opened or closed). A fourth location determinant is connectivity information, such with an external connection (e.g., a connection to a communication network or another device) and the type of the external connection. Connectivity information may indicate usage of a device and/or a location based on a network or another device to which the device is connected. A connection to an automobile via Bluetooth may be indicative that a user is in an automobile. A fifth determinant may be calendar information that may indicate a schedule of a person, who is a resource for a scheduled service. The schedule may be used to determine whether a resource will be available. In some embodiments, a client device may be configured to prompt a user at a graphical interface for information about a location of a resource. Collectively, the determinants may be useful for determining where a resource may be located, and/or whether the resource is moving towards a destination for a scheduled service and/or within the vicinity of the destination. All or some of the determinants may not be determined depending on whether the client device is associated with a resource that is a person or an object.

In some embodiments, client device 302 and/or client device 304 may be configured to process the information for location determinants to perform multi-factor location analysis. The device(s) may be configured based on an app or program code on the device(s). The app may process information from a device to determine location determinants for the device. At steps 316 and 326, client device 302 and client device 304, respectively, may send location determinant information about location determinants to resource management system 140. The location determinant information may be based on the location determinants for which data is obtained at steps 314 and 316.

At step 330, resource management system may process location determinant information to perform multi-factor location analysis for a resource. Location determinants may be considered based on the rule(s) of a policy. Each location determinant may be considered as a factor for location analysis. Location determinants may be categorized within different levels of factors depending on the rule considered for location analysis. Some location determinants may be secondary or tertiary factors that are considered after primary determinants are considered. Each factor may be assigned a weight depending on criteria including the rule(s), the resource, the schedule, the level of determinant, the service, or combinations thereof. Resource management system 140 may implement multi-factor location analysis of location determinants in a variety of ways. Location analysis may be performed based on the polici(es) assessed at step 310.

In one example, resource management system 140 may determine whether the resource is within proximity to a destination where a service is to be provided. Proximity may be defined based on a threshold distance and/or a time period when analysis is performed. Proximity may be assessed based on GPS coordinates of location determinant information. The GPS coordinates may be used to determine a distance to a location defined by GPS coordinates of a destination where a service is scheduled for the resource. The threshold distance may be a short distance to the location for the service, such that the threshold distance is defined to consider whether a resource can be “checked-in” or considered to have arrived within a time period. Upon determining that a resource is within the proximity to the destination, processing may include determining whether the rate of movement from the location to the destination satisfies a threshold when the client device is a particular distance from the destination. The rate of movement may be defined based on one or more location determinants, such as a mode of transportation, a rate of movement based on GPS coordinates, a flow of traffic on a path using an automobile, or combinations thereof. The threshold may be defined as a time period for travel. The threshold may be defined based different depending on when the processing of location determinants is performed. The threshold may be defined as a time period based on a difference when location analysis is performed and the service is scheduled.

Resource management system 140 may communicate with third-party system 120 to determine a movement data related to movement of a client device. Movement data may include traffic information to assess a travel time and/or average speed of traffic for determining a total travel time from the location of the resource to the destination. The travel time may be compared to the threshold to determine whether the resource will arrive by the scheduled time. Upon determining that a resource is within proximity and/or can arrive within a particular time period, location determinants may be considered during a time period to assess a direction of travel as a determinant. A location of a resource may be determined from multiple sets of location determinants during a time period. The analysis described above may be performed for subsequent sets of location determinants. Upon determining that thresholds are satisfied for a policy to assess availability of the resource(s) for a scheduled service, the location determined at different times in the time period may be compared to determine whether a distance to a destination for the service is reduced. This location analysis may be useful for determining whether a resource is moving in a direction closer to a destination for a scheduled service.

The time period for a policy may be defined for analyzing the location of resources for availability. Responses may be received after a time period for determining location determinants. Resource management system 140 can determine whether a client device is responsive. In some embodiments, a lack of response may be indicative that a resource may not be available. Resource management system 140 may determine that a client device which is not responsive to a request for location determinants may be considered unavailable. Resource management system 140 may attempt to communicate with multiple client devices to perform location analysis. Each of the client devices may be registered as being associated with a resource. Resource management system 140 can receive responses including location determinants as a delayed response when a client device is able to communicate with resource management system 140. Resource management system 140 may perform location analysis 330 using a delayed response if permitted according to the rule(s) defined by a policy.

Different levels of factors for location determinants may be considered for location analysis. In some embodiments, location determinants for assessing a location of a client device and movement of the client device may be useful in first determining whether a resource associated with the client device can reach a destination within a reasonable time of a scheduled service. Location determinants for assessing whether a client device is operable and/or in use may be useful for assessing whether the client device may be usable to perform location analysis of a resource. Some location determinants may be used for multiple levels of factors. Movement data, such as data from a gyroscope of a client device, or usage of an application may be used to determine whether the client device is actively used such that it is reliable for performing location analysis. Specific data about applications used on a device may be used to determine whether a client device is in use by a particular user, such that an assessment of location can be made based on the client device. In some embodiments, data about connectivity of a client device to another device may be used to determine usage of the client device, movement of the client device, and/or location of the client device. Location determinants may be considered for location analysis based on the rule(s) of the policy for assessing scheduling of a service.

Upon determining that a client device is within proximity to a destination for a service, resource management system 140 can perform location analysis of the client device. The rule(s) may define thresholds by which a location assessment can be made if and when the client device may reach the destination. Thresholds may be defined for each location determinant, such as a distance, a rate of movement, a mode of transportation, or combinations thereof. In some embodiments, location analysis for scheduling of a service may be based on location analysis of multiple resources, such as each resource associated with each of the client devices 302 and 304. Resource management system 140 can determine whether scheduling for a service can be provided based on availability of all resources or some resources for a service. Availability may be assessed based on the rule(s) of a policy, such as whether thresholds for location determinants are satisfied. Availability of a resource may be determined based on whether the rule(s) of the policy are satisfied.

At step 332, resource management system 140 can determine one or more operations to perform based on location analysis performed at step 330.

In at least one embodiment, one or more operations are performed for communicating with service provider system 110 to provide a service provider with information (e.g., results) based on location analysis. For example, resource management system 140 may provide information about a schedule status for a service to service provider system 110. The information may include, without limitation, results of location analysis including details about whether a resource is available for a scheduled service and an estimated time of arrival.

Information may be provided for one or more resources for which location analysis is performed. Information may be provided periodically to service provider system 110. Information may be communicated in real-time based on location analysis 330 performed for responses received during a time period between time 308 and time 328. The information may be provided via one or more communication networks. In some embodiments, information may be provided in a graphical interface according to techniques disclosed herein.

In some embodiments, resource management system 140 may assess a schedule for a service on behalf of service provider system 110. One or more operations are performed to assess a schedule for a service based on the location analysis of one or more resources. Resource management system 140 may use the policy to assess a schedule for a service based on location analysis 330 for resources. An assessment can be made that a scheduled service cannot be performed based on determining that a resource is unavailable.

Upon determining, using location analysis, that a resource is unavailable for a scheduled service, resource management system 140 may perform one or more operations to determine whether the service can be rescheduled based on availability of all resources for the service. A policy may define one or more rules for assessing whether a service can be performed at a scheduled time. The rules may define the criteria for rescheduling including location determinants to consider for location analysis. The criteria may be used to define one or more rules based on when a determination can be made whether to reschedule a service and if so, the criteria for rescheduling. One operation may include requesting service provider system 110 to provide schedule information about other services scheduled for a time period (e.g., a day). The schedule information may include information about resources and their availability. The availability may be based on previous assessment of location analysis 330. The schedule information may indicate when a service can be scheduled. Based on the schedule information, resource management system 130 can perform process 300 for assessing availability of resources for scheduling the service at possible available times. Resource management system 140 may perform one or more operations to communicate possible time periods during which a service may be rescheduled. Resource management system 140 may perform location analysis to determine different client devices for which resources are available within the rules of a policy. The resources may be identified based on information provided by service provider system 110.

A graphical interface may be updated to indicate the status information for scheduling a service based on location analysis 330. Upon determining, using location analysis 330, that a service can be performed at a scheduled time for the resources that are assessed, a graphical interface may be updated to indicate that the service can be performed. Different graphical interfaces may be provided to client devices and service provider system 110.

In some embodiments, resource management system 140 may perform operations for scheduling services. In a first example, one type of operation 332 is automatic check-in, which is determined based on location analysis 330 of a resource within proximity to a destination of a service provider to receive a scheduled service. The location analysis information 340 may include information indicating whether a resource can be automatically checked-in. The schedule information received at 344 may include information to provide to the resource after automatically checking in. Examples of information are disclosed with reference to FIG. 4. In a second example, one type of operation 332 is performing location analysis with respect to a client device to determine scheduling for a service when a resource is not likely available to attend a service. In some embodiments, resource management system 140 may perform an operation 332 to assess a likelihood of availability based on location analysis following a policy. Operations may be performed depending on the rule(s) in the policy according to the likelihood of availability.

At step 342, service provider system 110 may perform one or more operations based on the location analysis information 340. Service provider system 110 may process the location analysis information 340 to determine schedule information. Operations may include processing input from a graphical interface, such as the graphical interfaces described with reference to FIG. 4. Schedule information 344 may be sent based on input received from the graphical interface. The information 344 may include operations to perform with respect to scheduling a service. The operations indicated by information 344 may include rescheduling and/or performing further location analysis with respect to client devices 302, 304 or client devices with respect to other resources. The information 344 may include information about changes in schedule and/or availability of resources. The information 344 may include information received from a graphical interface described with reference to FIG. 4.

At step 350, resource management system 140 may communicate to client devices 302, 304 information based on location analysis 330. In the example of FIG. 3, information is communicated to client device 302. The information may cause a graphical interface to be updated at the client device. The graphical interface may be updated to display scheduling of a service, such as whether the service is scheduled, canceled, or whether the resource is checked-in for the service. The information may include information about the service (e.g., a notification about scheduling for the service), such as the examples disclosed with reference to FIG. 4. In one example, the information may include a relative location determined for the client device and a likelihood of arrival to the service provider if automatic check-in has not been performed. The information may include information 344 provided by service provider system 110. In some embodiments, the information sent at step 350 may include a request for a response. At step 352, client device 302 may display a graphical interface based on the information. The information may be displayed based on assessing the location analysis information. Input may be processed from the graphical interface in response to step 350. The graphical interface may provide options for the resource to select. At step 354, the client device 302 may send back one or more responses. The response(s) may be responsive to step 350.

At step 360, resource management system 130 may perform one or more operations in response to a communication from either or both of client devices 302 and service provider system 110. The operations may include facilitating communication between a client device of a resource and a service provider system. The operations may include conducting further location analysis based on a policy and the outcome of a previous location analysis 330. Resource management system 140 may update graphical interfaces for client devices and/or service provider system 110 based on communication from either of client devices and service provider system 110. Resource management system 140 can repeat all or some of the steps in process 300 until a service is rescheduled or being performed, after which one or more different policies may be assessed for a service. Operations at step 360 may include managing scheduling of a service as it is performed, including providing the service provider system 110 and/or the client device(s) with an update about the service. Service provider system 110 may provide resource management system 140 with updates including information as a service is performed so that the client device(s) can be updated with a status of the service.

### III. Interfaces for Service Management System

Graphical interfaces are disclosed for techniques implementing multi-factor location analysis of resources for managing scheduling of a service according to some embodiments.

Graphical interfaces disclosed herein may be accessible using a computer system, such as a client system. Graphical interfaces may be accessed at a client system by users (e.g., a customer or a service provider). The graphical interface of FIG. 4 may be accessed at a client system by a user of a service provider. In some embodiments, graphical interfaces are disclosed for a client system associated with a resource (e.g., equipment or device for providing a service) to provide a service.

An interface may include a physical interface, a graphical interface (e.g., a graphical user interface), an interface that is interactive to receipt input, or a combination thereof. A graphical interface may be generated by a client, received from resource management system 140, or a combination thereof. An interface may be provided by resource management system 140 via a network as part of a service (e.g., a cloud service or an enterprise service) or application. Client systems 108 may provide access to one or more applications (“apps”). An app may provide one or more interfaces to enable a user in service management system 100 to access and perform enhanced functions provided by resource management system 140. An app may be implemented as an app executing on an operating system of a client that provides the app, a web browser that interfaces with a web-based messaging service, a service-specific application provided by resource management system 140, or another app. For example, an app may be implemented by resource management system 140 and accessed from a client 108. In some embodiments, access to use an app may be provided as a service by resource management system 140.

Although some embodiments are described with a graphical interface including one or more graphical interfaces, any number and combination of graphical interfaces may be provided according to techniques disclosed herein. An example of a graphical interface is a graphical user interface (GUI). A graphical interface may be modified to display additional information or one or more additional graphical interfaces such as those described in this disclosure.

In some embodiments, a graphical interface may be interactive, such as having one or more elements that are interactive to receive input based on interaction. In this disclosure, “an element” may be included in an interface. An element may be displayable and/or part of an interface. Examples of elements include, without limitation, a control, a button, a navigation bar, or other visible component that can be part of an interface that can be perceived by sound, vision, touch, or combinations thereof. An element can receive input. For example, an interactive element may be an element that is interactive to receive input. An interactive element may receive input to enable interaction with the graphical interface. The elements may be interactive to display information and/or change a visualization of the interface. In some embodiments, the graphical interfaces disclosed herein can be displayed with or in response to interaction with a graphical interface of an application or a website. Instead of a graphical interface included in another graphical interface, one or more interactive elements may be implemented in the graphical interface to enable the same functionality. In response to interaction with a graphical interface as disclosed herein, resource management system 140 can perform processing to produce an updated or new graphical interface. The processes disclosed herein may be implemented through interaction with a graphical interface. The graphical interface(s) disclosed herein may be accessible (e.g., rendered) at a client system.

FIG. 4 illustrates a graphical interface 400 that enables a service provider to manage scheduling of services implemented by resource management system 140. Specifically, graphical interface 400 may initiate and/or facilitate management of scheduling for services based on multi-factor location analysis of resources. Graphical interface 400 may be presented at a client system accessible to or implemented in a service provider system. The examples in FIG. 4 are described with reference to services, each of which is provided by a service provider system.

In at least one embodiment, graphical interface 400 may be presented with one or more records, each corresponding to scheduling for a different service. Each record may be displayed in a variety of ways, such as a row in the graphical interface. Each record may be interactive including one or more elements to support interactive functionality including operations to manage a schedule for a service and/or adjust a schedule of a service. Examples of operations are described below. Each record may be presented with a visual appearance and/or an audio presentation to indicate all or some information presented for the record.

Each record may be shown with user information about a user receiving a service and a client device associated with the user. Each record may be shown with scheduling information for providing a service to a customer. Each record may be associated with a data accessible from or provided by service provider system. The data may include information about a service and scheduling for the service. The data record may include data based on location analysis provided by resource management system 140. For example, a record for a scheduled service may include location analysis information provided by resource management system 140 for assessing scheduling of a service. Scheduling information may include, without limitation, a time for a scheduled service, also referred to herein as “appointment time” (“Apt time”), an estimated time of arrival (“ETA”), or status information (e.g., confirmed or unconfirmed). ETA may be provided based on location analysis information. In some embodiments, location analysis information may include information about any location determinants considered. For example, location analysis information may include a proximate location, an ETA, and status information based on whether a response is received from a client of a resource. Any of the scheduling information may be presented to indicate a status of a schedule for a service. For example, the ETA may be presented with a visual appearance to indicate a time estimated after a scheduled time.

Each record may be shown with information including, without restriction, resource information about the resource(s) (e.g., a service person, a customer, one or more devices to provide a service, service facilities, etc.) for providing a service including a user scheduled to receive a service. For example, the record for a scheduled service may be shown with the resource(s) considered for location analysis and information about availability of those resources. In some embodiments, a record may be presented with options about alternative resources and/or schedules for a scheduled service.

In the example shown in FIG. 4, each record for a scheduled service is shown with information about the scheduled service including a client name (e.g., a name associated with a client for a customer scheduled to receive a service) and an Apt time. Each record is shown with location analysis information including ETA and status indicating whether the client has confirmed travel to the service provider for the scheduled service.

In some embodiments, each record may be presented with one or more interactive elements (e.g., schedule management controls) for performing operations for managing scheduling of a service. Operations may be initiated automatically, which can be configured based on interaction with an element shown for a record. One type of operation includes communication with a client device of a resource (e.g., a customer). Communication may include telephone calls, short messaging system (SMS) communication, or other types of communication. Communication may be facilitated through resource management system 140 to ensure communication is in accordance with patient communication preferences. Another type of operation includes management operations such as automatic cancel (e.g., auto cancel) or canceling of a service. Such operations may be initiated based on assessment of a schedule presented using location analysis information. Interaction with an element may initiate an operation. Other types of operations may include schedule management, such as reschedule and adjust schedule. Schedule management options may enable requesting communication with a client of a resource to request availability, to cancel, and/or to provide alternative options for scheduling based on availability of resources. In some embodiments, a record may be shown with alternative scheduling options and/or availability of resources including scheduling options for resources. The presentation of a record may be updated in real-time based on changes in scheduling and/or information received from resource management system 140. In some embodiments, a record may include an interactive element for check-in. The interactive element may enable automatic check-in including configuration of notifications and status updates about check-in of a person scheduled for a service based on location analysis. The functionality may enable a service provider to communicate and/or indicate to a client device procedures and/or status updates about a service to be provided for the check-in. In some embodiments, the graphical interface may provide profile information for a person scheduled for a service based on check-in for a service determined using location analysis.

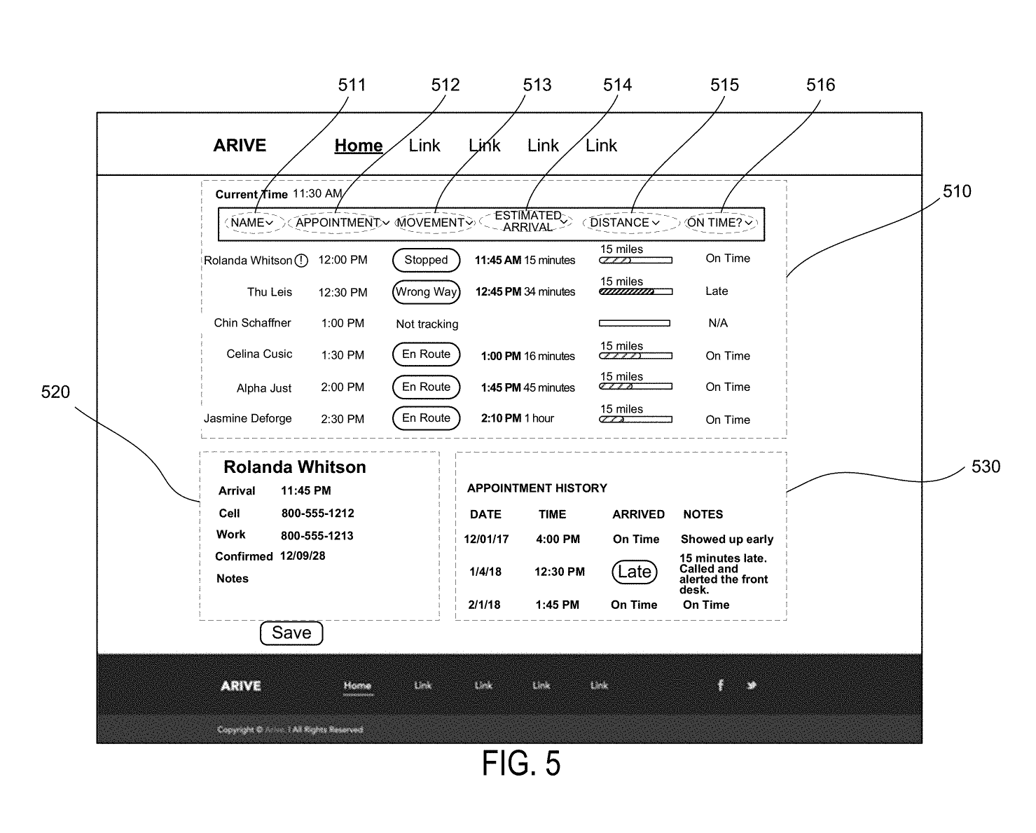

FIG. 5 shows another graphical interface of an application. In FIG. 5, a graphical interface 500 include three areas, i.e. a record area 510, a client information area 520, and an appointment history area 530. The record area 510 includes appointment records maintained by the resource management system 140. In the example, the record area 510 includes a name field 511 for displaying the name of the client, an appointment time field 512 for displaying the appointment time for the client to receive a service, a movement status field 513 for displaying the movement status of the client, an estimated time of arrival field 514 for displaying the estimated time of arrival of the client, a distance field 515 for displaying the distance of the client to the service provider system 110, and an on-time indicator field 516 for displaying whether the client can arrive on time. Specifically, the movement status field 513 may display the movement status of the client, such as Stopped, Wrong Way, and En Route. The movement status field 513 can also display Not Tracking if the movement status of the client is not available. The estimated time of arrival field 514 may also display the time remaining for the client to arrive at the service provider system 110. The distance field 515 may use, for example, progress bar with different colors, such as red, yellow and green, to show the distance of the client to the service provider system 110. The on-time indicator field 516 may display whether the client can arrive on time, such as On Time or Late. It can also display N/A if the location of the client is not available.

The client information area 520 may display certain personal information authorized by the client when he/she made the appointment to receive a service. Such personal information may include, for example, name, time of arrival, cell phone number, work telephone number, and date of confirmation of the appointment. Those of ordinary skills in the art may contemplate to add or reduce such personal information according to a particular application of the disclosure.

The appointment history area 530 may display the appointment history of a particular client within the resource management system 140. Such appointment history may include, for example, the date and time of previous appointments, whether the client arrived on time, and other relevant information. Those of ordinary skills in the art may contemplate to add or reduce information of the appointment history of the client according to a particular application of the disclosure.

In certain embodiments, a graphical interface presented on a client device for a service provider may provide statistical information about scheduling of services. The statistical information may be provided by resource management system 140 based on analysis of availability of resources for scheduled services. The statistical information may include efficiency reports indicating a measure of wait time for clients, rates of resources that show up for services, and rates of services that are completed according to schedule and not completed according to schedule. The statistics may enable a service provider to improve efficiency for operation for scheduling services.

In some embodiments, each client associated with a resource necessary for a service may present a graphical interface for managing scheduling of services involving the resource. The information presented in the graphical interface may be obtained from resource management system 140 and/or service provider system 110. Some of all of the functionality and/or information disclosed herein for graphical interfaces may be shown in a client device associated with a resource. Each client may provide a graphical interface in an app.

A graphical interface may be presented at a client device to provide information about a scheduled service including details about the service. In some embodiments, the graphical interface may present information about a service as it is in progress. The information may be presented based on analysis of a schedule considering availability of the resources for the service.

In some embodiments, resource management system 140 may provide updates to a client device based on location analysis of resources for a service. A graphical interface may be presented at the client device to provide information about the updates. For example, a graphical interface may present a status of a scheduled service based on location analysis of resources for the service. The graphical interface may present status of a scheduled service and alternative options for a service based on whether the service is canceled and/or not obtainable based on the schedule considering the location analysis. In some embodiments, the graphical interface may be interactive to confirm availability for a service and/or provide additional information about availability.

A graphical interface provided at a client device for a resource may provide options for a scheduled service. Options may be presented, either as an alternative or a new service, based on availability determined from service provider system after considering location analysis information for services. The graphical interface may provide incentives including rewards, awards, discounts, coupons, and/or services. Incentives may be provided with respect to available services during available schedules. Incentives may be provided to client devices based on proximity to a service provider considering location analysis of those client devices.

In some embodiments, a graphical interface at a client device may be presented to provide information about a service including preparation information in advance and/or during the service. The graphical interface may provide notifications about a scheduled service leading up to the service, during the service, and after the service. The notifications may include reminders and/or scheduling information including an assessment of the schedule based on location analysis.

A graphical interface at a client device may be presented for providing information about a check-in status for a service. The information may indicate whether a person is checked in for a service including automatic check-in based on proximity determined by location analysis. Any functions of the graphical interface may be presented based on check-in for a service. In some embodiments, the graphical interface may provide a status indicator for the service and/or steps during the service based on check-in for the service. Directions for the service including a waiting location may be provided based on check-in for a service.

In some embodiments, a graphical interface presented to a client device may facilitate communication with a service provider. A service provider may provide a resource with updates about a scheduled service. Updates may be provided based on past attendance and/or likelihood of arrival for a scheduled service as the scheduled time approaches. The graphical interface may enable a customer to communicate with a service provider for questions related to a service including administrative questions.

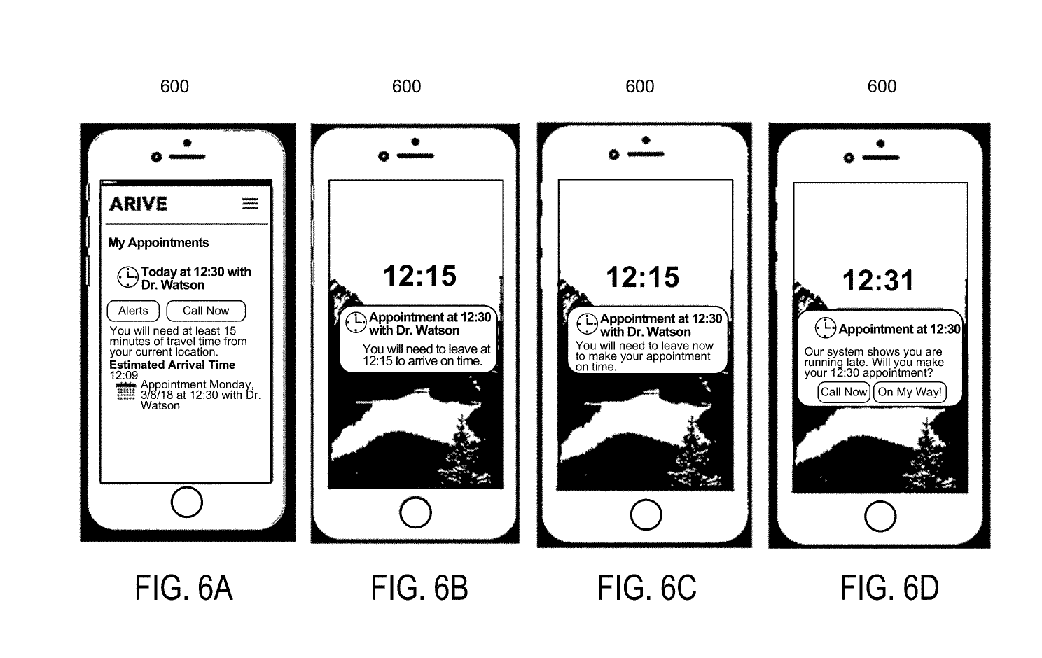

FIG. 6A-6D illustrates an example of the graphical interface presented to a client on a client device. As shown in FIG. 6A, the graphical interface 600 may display the detail information of the incoming appointment, the estimated time of travel to arrive on time, and the estimated time of arrival. In the example as shown FIG. 6A, the graphical interface 600 also provides interactive buttons to help the client alert himself/herself, or to make a phone call in relation to the appointment. In FIG. 6B and 6C, the graphical interface 600 may display reminders to the client about the incoming appointment and alert the client to leave based on the location analysis in order to arrive on time. In FIG. 6D, the graphical interface 600 may facilitate communication with the service provider system 110. As shown in FIG. 6D, the client is running late for the appointment, the graphical interface 600 may provide interaction button to help the client to communicate with the service provider system to confirm, postpone, or cancel the appointment.

### IV. Example Scenarios of Multi-factor Location Analysis of a Resource

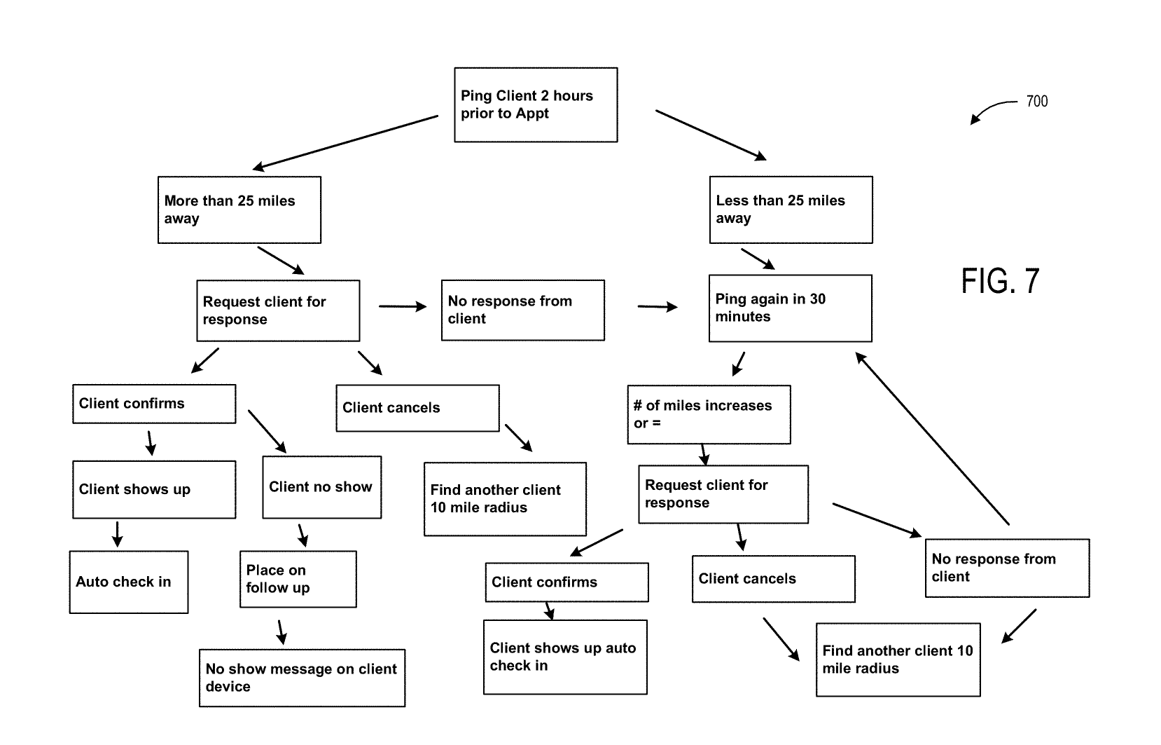

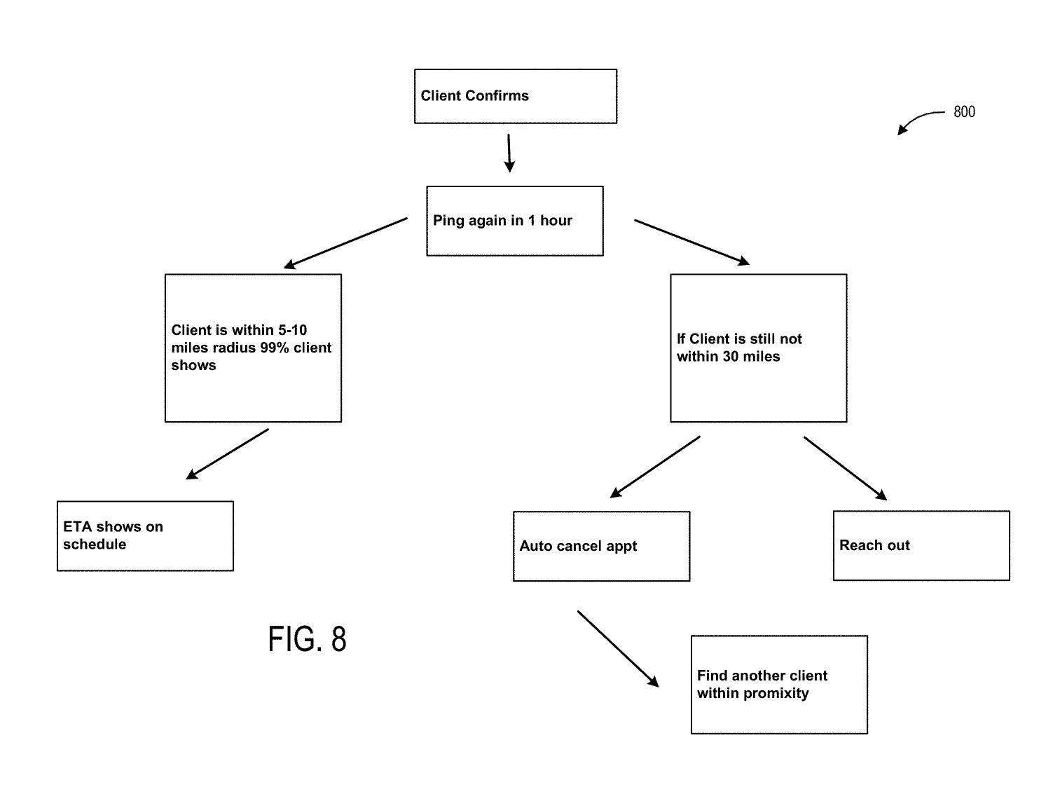

FIGS. 7 and 8 illustrate examples of processes for multi-factor location analysis of a resource according to some embodiments. These processes may be implemented by some of elements in service management system 100. Techniques disclosed and features disclosed with reference to FIGS. 2-3 are implemented in process 700.

FIG. 7 illustrates a process 700 for location analysis based on a policy for managing scheduling of a service. Process 700 may be initiated by assessing a policy for managing scheduling of a service. In the example of FIG. 7, a policy for a service may be defined by a threshold time period (e.g., two hours prior to an appointment for a service). Upon satisfying the threshold time period, resource management system 140 may communicate with one or more resources (e.g., a client device of a customer scheduled for the service) to obtain location determinants for assessing a location of the customer. Location analysis may be performed to determine whether a threshold distance (e.g., 25 miles from a service provider of the service) is satisfied by the location of the client device. Multiple client devices of the customer may be requested (e.g., “pinged”) for location determinants. For example, the resource management computer system 140 may detect whether the threshold distance has been reached by the location of the client device. In certain embodiments, the threshold distance may be configured based on the policy, such as 25 miles from a service provider of the service.

Upon determining that a client device does not satisfy the rule (e.g., a threshold distance) according to the policy, resource management system 140 may facilitate communication with the client device to attempt to obtain a response from the customer. The client device may be periodically pinged for location determinants to assess, in real-time, a relative location of the customer for assessing scheduling for a service. In this example, whether or not the client device does not respond or the distance threshold is satisfied, the client device may be requested again for location determinants after a second threshold time period.

In some embodiments, resource management system 140 may request a customer of a client device, which does not satisfy a rule for a policy, for a response to confirm or deny availability of the customer for a scheduled service. For example, based on detecting that the threshold distance is not reached, the resource management computer system 140 may send to the client device a request for confirming to receive the service as scheduled. Upon receiving a response that the customer will show, resource management system 140 may further request location determinants according to a schedule to perform location analysis. The location analysis results may be provided to a service provider to enable a service provider system to automatically check-in the customer when the client device is within proximity to or at a destination of the service provider. In certain embodiments, the proximity may be configured based on the policy, such as 1 miles to the service provider. Upon receiving a response that the customer will not show, resource management system 140 may communicate with a service provider system to schedule a follow-up service schedule. For example, the resource management computer system 140 may send to another client device associated with another client a request to confirm to receive the service. The other client device for making use of the missed service time may be determined based on the policy. In certain embodiment, the resource management computer system 140 may receive a response from the another client device to indicate whether the other client will be available to receive the service. Resource management system 140 may send information to the client device to indicate details about the missed current appointment and/or future scheduled services. For example, the resource management computer system 140 may send to the service provider system 110 a reschedule request for rescheduling the service for the client that missed the appointment. Then, the resource management computer system 140 may receive from the service provider system 110 a reschedule response indicating an available time for the client who missed the appointment to come again to receive the service. In certain embodiments, the resource management computer system 140 may send to the client device of the client who missed the appointment a confirmation request for the rescheduled time. The client who missed the appointment may decide if he/she will accept the rescheduled appointment, and inform the resource management computer system 140. The resource management computer system 140 may receive from the client device a confirmation response indicating whether the client who missed the service accepts the rescheduled time. For this rescheduled time, the resource management computer system 140 may implement the location analysis according to the above described embodiment of the present disclosure.

Upon determining that a client device has not responded and/or that a rule of a policy is not satisfied by the proximate location of the client device, location analysis may be conducted. Location analysis may be conducted periodically, which may be defined based on a policy. In this example, after a threshold waiting time period (e.g., 30 minutes), resource management system 140 may obtain location determinants of the client device to perform location analysis. For example, the resource management computer system 140 may determine a threshold waiting time period according to the policy. Upon detecting the threshold waiting time period has been reached, the resource management computer system 140 may send to the client device a repeat request for the plurality of location determinants. Then the resource management computer system 140 may receive from the client device a repeat response which comprises an updated plurality of location determinants. In this instance, resource management system 140 may perform location analysis for a rule to determine whether the client device is moving closer or further away from a destination of the scheduled service. The distance of the client device may be compared to a previous distance when location analysis was previously performed. The distance may be assessed to determine whether the distance increased or decreased. Resource management system 140 may send a request to the client device for a response by the customer regarding availability to attend the service. For example, the resource management computer system 140 may determine, based on the plurality of location determinants comprised in the response and the updated plurality of location determinants comprised in the repeat response, the client is moving away from a destination for providing the service. In this case, the resource management computer system 140 may send to the client device a request for confirming that the client will be able to receive the service. If the client will be available and plans on coming to receive the service, he/she will confirm the appointment. Otherwise, he/she will decline or cancel the appointment. The resource management computer system 140 may receive from the client device a response indicating whether the client will be able to receive the service. If the resource management computer system 140 determines from the response that the client will be available to receive the service, the resource management computer system 140 may check the client in, for example when the client is within the proximity of the service provider.

In some embodiments, the resource management computer system 140 may communicate with the third party system 120 to obtain movement data related to the movement of the client device in order to perform the location analysis. The third party system 120 may be determined according to the policy. For example, the resource management computer system 140 may send to a traffic information system determined based on the policy, a request for movement data related to the movement of the client device. Then the resource management computer system 140 may receive from the traffic information system a response comprising the movement data. In certain embodiments, the resource management computer system 140 may perform the location analysis using the plurality of the location determinants and the movement data. For example, the resource management computer system 140 may determine an estimated time of arrival for the client.

In some embodiments, resource management system 140 may determine whether to inform other possible resources (e.g., customers) about an availability for scheduling a service based on a resource that is unavailable to show. Such a determination may be made in many ways. For example, resource management system 140 may determine that a customer is not going to show for a scheduled service based on a response from a client device indicating a direct request by a user to cancel a scheduled service. In another example, a determination that a customer may not show is made based on a rule (e.g., a distance threshold) in a policy that is not satisfied. In any case, resource management system 140 may inform a service provider system about a no show. Service provider system may request resource management system 140 to identify other client devices within proximity, defined by a policy, which may be available for a service. Resource management system 140 may utilize location analysis techniques to identify possible candidates based on proximate location. Resource management system 140 may communicate with the identified client devices to offer availability of services.

FIG. 8 illustrates a process 800 for location analysis based on a policy for managing scheduling of a service. Process 800 may be initiated by assessing a policy for managing scheduling of a service. In this example, a policy for a service may be defined by a threshold time period (e.g., two hours prior to an appointment for a service). Prior to a threshold defined in a rule, resource management system 140 may receive a response from a client device confirming availability for a scheduled service. Upon reaching the threshold time period, resource management system 140 may request location determinants from a client device of a resource (e.g., a customer) scheduled to receive the service.

Resource management system 140 may perform location analysis based on the location determinants to assess a rule for determining availability of the resource. In this example, the rule is defined based on multiple thresholds. A first threshold is defined by a range of 5-10 miles or less. A second threshold may be defined by 30 miles or more. Location analysis may be performed to assess the location of the client device for each of the thresholds. Upon determining that the client device satisfies the first threshold, resource management system 140 may send location analysis information to a service provider system based on location analysis of the first threshold. The location analysis information may indicate that the resource is available on schedule to receive the service. Upon determining that the client device satisfies the second threshold (e.g., meets or exceeds the second threshold), resource management system 140 may send location analysis information to a service provider system based on location analysis of the first and second threshold. The location analysis information may indicate that the resource is likely not available for the service based on satisfying the second threshold.

The service provider system may provide a graphical interface of results based on the location analysis information. For example, the service provider system may display a likelihood of availability for a service based on the results of analysis of the first and second thresholds. The service provider system may display operations performed by resource management system 140 based on the results. For example, the graphical interface may indicate that a scheduled service has been automatically canceled and the client device notified. The graphical interface may display clients that have been asked about availability for filling the scheduled appointment that cannot be met.

Resource management system 140 may perform operations based on the location analysis. The operations may be performed based on response from a service provider system and/or based on a policy indicating operations to perform. In the example of FIG. 8, upon determining that the second threshold is satisfied, resource management system 140 may automatically cancel the scheduled service and send a communication to the client device associated with the resource for which the service is canceled. Resource management system 140 may perform operations to identify other client devices for resources that may be available for a service based on proximity of the client devices.

Processes disclosed with reference to FIGS. 7 and 8 may be multiple times to maximize scheduling of services to minimize loss of resources.

Although, above disclosure generally discusses automatic “check-in” of a resource as it relates to a client, it should be noted that neither is the resource, nor is the automatic “check-in” itself limited to clients. For example, a resource could also include an employee or staff member needed for performing a service. And the resource management system may also automatically “check-in” an employee or staff member needed for completing a service. For example, embodiments discussed herein may apply to employees or staff members with specific skillset needed to complete a specific service. In the absence of availability of such members, the service cannot be performed. In such instances, above embodiments may also include a similar process of checking the availability of the employee/staff member and determining if the employee/staff member will be available in time to enable performing the scheduled service. The resource management system may perform this determination similar to the embodiments described above where the resource management system determines the location of the employee or staff member and the estimated time of the employee or staff member for reaching the facility in conjunction with communication with the employee or staff member using their device. If the employee/staff member will not be available, the resource management system may reschedule the service and try and accommodate another service for the same or different client for which the requisite resources are available.

Furthermore, although the above disclosure is described in terms of providing a service for a client, such services may also include general employment and performance of tasks that are not specific to a particular client. For example, the above resource management system may also be used in automatically managing employee check-in/check-out times for an employer. For example, if it is determined based on the parameters provided to the resource management system and/or analysis by the resource management system that a particular number of cashiers are needed at a store, the resource management system may automatically determine if the requisite number of cashiers would be available at any given point in time, track all employees that are scheduled to arrive and leave and based on ability (or inability) of the employees to arrive on time or arrive to work at all, schedule additional employees/resources for performing the cashier services at the store. In this manner, as described previously, the resource management store can track, check-in and check-out all employees and maintain continuity of service at the store.

### V. Computer Systems for a Resource Management System and Client Systems

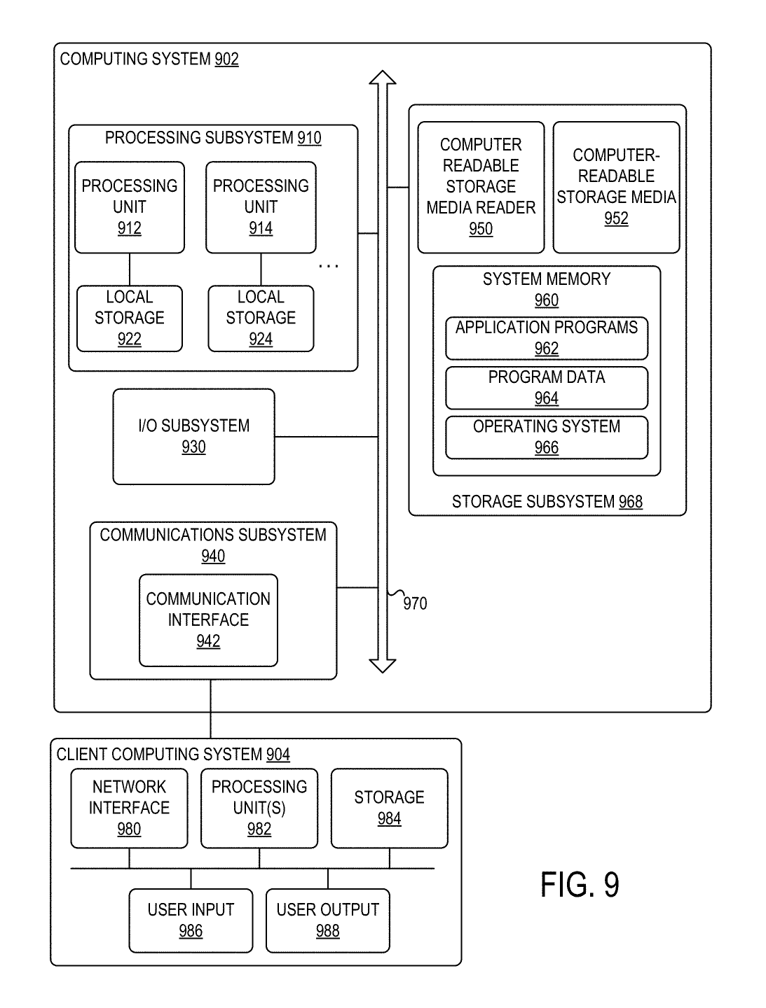

Various operations disclosed herein may be implemented on computer systems, which may be of generally conventional design. FIG. 9 shows a simplified block diagram of a representative computing system 902 and client computing system 904 usable to implement certain embodiments of the present disclosure. In various embodiments, computing system 902 or similar systems may implement resource management system 140, or any other computing system disclosed herein or portions thereof. Client computing system 904 or similar systems may implement client system 104, or other client systems disclosed herein.

Computing system 902 may be one of various types, including a handheld portable device (e.g., an iPhone® cellular phone, an iPad® computing tablet, a PDA), a wearable device (e.g., a Google Glass® head mounted display), a personal computer, a workstation, a mainframe, a kiosk, a server rack, or any other data processing system.

Computing system 902 may include processing subsystem 910. Processing subsystem 310 may communicate with a number of peripheral systems via bus subsystem 970. These peripheral systems may include I/O subsystem 930, storage subsystem 968, and communications subsystem 940.

Bus subsystem 970 provides a mechanism for letting the various components and subsystems of server computing system 904 communicate with each other as intended. Although bus subsystem 970 is shown schematically as a single bus, alternative embodiments of the bus subsystem may utilize multiple buses. Bus subsystem 970 may form a local area network that supports communication in processing subsystem 910 and other components of server computing system 920. Bus subsystem 970 may be implemented using various technologies including server racks, hubs, routers, etc. Bus subsystem 970 may be any of several types of bus structures including a memory bus or memory controller, a peripheral bus, and a local bus using any of a variety of bus architectures. For example, such architectures may include an Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus, which may be implemented as a Mezzanine bus manufactured to the IEEE P1386.1 standard, and the like.

I/O subsystem 930 may include devices and mechanisms for inputting information to computing system 902 and/or for outputting information from or via computing system 902. In general, use of the term “input device” is intended to include all possible types of devices and mechanisms for inputting information to computing system 902. User interface input devices may include, for example, a keyboard, pointing devices such as a mouse or trackball, a touchpad or touch screen incorporated into a display, a scroll wheel, a click wheel, a dial, a button, a switch, a keypad, audio input devices with voice command recognition systems, microphones, and other types of input devices. User interface input devices may also include motion sensing and/or gesture recognition devices such as the Microsoft Kinect® motion sensor that enables users to control and interact with an input device, the Microsoft Xbox® 360 game controller, devices that provide an interface for receiving input using gestures and spoken commands. User interface input devices may also include eye gesture recognition devices such as the Google Glass® blink detector that detects eye activity (e.g., “blinking” while taking pictures and/or making a menu selection) from users and transforms the eye gestures as input into an input device (e.g., Google Glass®). Additionally, user interface input devices may include voice recognition sensing devices that enable users to interact with voice recognition systems (e.g., Siri® navigator), through voice commands.

Other examples of user interface input devices include, without limitation, three dimensional (3D) mice, joysticks or pointing sticks, gamepads and graphic tablets, and audio/visual devices such as speakers, digital cameras, digital camcorders, portable media players, webcams, image scanners, fingerprint scanners, barcode reader 3D scanners, 3D printers, laser rangefinders, and eye gaze tracking devices. Additionally, user interface input devices may include, for example, medical imaging input devices such as computed tomography, magnetic resonance imaging, position emission tomography, medical ultrasonography devices. User interface input devices may also include, for example, audio input devices such as MIDI keyboards, digital musical instruments and the like.

User interface output devices may include a display subsystem, indicator lights, or non-visual displays such as audio output devices, etc. The display subsystem may be a cathode ray tube (CRT), a flat-panel device, such as that using a liquid crystal display (LCD) or plasma display, a projection device, a touch screen, and the like. In general, use of the term “output device” is intended to include all possible types of devices and mechanisms for outputting information from computing system 902 to a user or other computer. For example, user interface output devices may include, without limitation, a variety of display devices that visually convey text, graphics and audio/video information such as monitors, printers, speakers, headphones, automotive navigation systems, plotters, voice output devices, and modems.

Processing subsystem 910 controls the operation of computing system 902 and may comprise one or more processing units 912, 914, etc. A processing unit may include one or more processors, including single core processor or multicore processors, one or more cores of processors, or combinations thereof. In some embodiments, processing subsystem 910 may include one or more special purpose co-processors such as graphics processors, digital signal processors (DSPs), or the like. In some embodiments, some or all of the processing units of processing subsystem 910 may be implemented using customized circuits, such as application specific integrated circuits (ASICs), or field programmable gate arrays (FPGAs). In some embodiments, such integrated circuits execute instructions that are stored on the circuit itself. In other embodiments, processing unit(s) may execute instructions stored in local storage, e.g., local storage 922, 924. Any type of processors in any combination may be included in processing unit(s) 912, 914.

In some embodiments, processing subsystem 910 may be implemented in a modular design that incorporates any number of modules (e.g., blades in a blade server implementation). Each module may include processing unit(s) and local storage. For example, processing subsystem 910 may include processing unit 912 and corresponding local storage 922, and processing unit 914 and corresponding local storage 924.

Local storage 922, 924 may include volatile storage media (e.g., conventional DRAM, SRAM, SDRAM, or the like) and/or non-volatile storage media (e.g., magnetic or optical disk, flash memory, or the like). Storage media incorporated in local storage 922, 924 may be fixed, removable or upgradeable as desired. Local storage 922, 924 may be physically or logically divided into various subunits such as a system memory, a ROM, and a permanent storage device. The system memory may be a read-and-write memory device or a volatile read-and-write memory, such as dynamic random access memory. The system memory may store some or all of the instructions and data that processing unit(s) 912, 914 need at runtime. The ROM may store static data and instructions that are needed by processing unit(s) 912, 914. The permanent storage device may be a non-volatile read-and-write memory device that may store instructions and data even when a module including one or more processing units 912, 914 and local storage 922, 924 is powered down. The term “storage medium” as used herein includes any medium in which data may be stored indefinitely (subject to overwriting, electrical disturbance, power loss, or the like) and does not include carrier waves and transitory electronic signals propagating wirelessly or over wired connections.

In some embodiments, local storage 922, 924 may store one or more software programs to be executed by processing unit(s) 912, 914, such as an operating system and/or programs implementing various server functions such as functions of resource management system 140, or any other server(s) associated with resource management system 140. “Software” refers generally to sequences of instructions that, when executed by processing unit(s) 912, 914 cause computing system 902 (or portions thereof) to perform various operations, thus defining one or more specific machine implementations that execute and perform the operations of the software programs. The instructions may be stored as firmware residing in read-only memory and/or program code stored in non-volatile storage media that may be read into volatile working memory for execution by processing unit(s) 912, 914. In some embodiments the instructions may be stored by storage subsystem 968 (e.g., computer readable storage media). In various embodiments, the processing units may execute a variety of programs or code instructions and may maintain multiple concurrently executing programs or processes. At any given time, some or all of the program code to be executed may be resident in local storage 922, 924 and/or in storage subsystem including potentially on one or more storage devices. Software may be implemented as a single program or a collection of separate programs or program modules that interact as desired. From local storage 922, 924 (or non-local storage described below), processing unit(s) 912, 914 may retrieve program instructions to execute and data to process in order to execute various operations described above.

Storage subsystem 968 provides a repository or data store for storing information that is used by computing system 902. Storage subsystem 968 provides a tangible non-transitory computer-readable storage medium for storing the basic programming and data constructs that provide the functionality of some embodiments. Software (programs, code modules, instructions) that when executed by processing subsystem 910 provide the functionality described above may be stored in storage subsystem 968. The software may be executed by one or more processing units of processing subsystem 910. Storage subsystem 968 may also provide a repository for storing data used in accordance with the present disclosure.

Storage subsystem 968 may include one or more non-transitory memory devices, including volatile and non-volatile memory devices. As shown in FIG. 9, storage subsystem 968 includes a system memory 960 and a computer-readable storage media 952. System memory 960 may include a number of memories including a volatile main RAM for storage of instructions and data during program execution and a non-volatile ROM or flash memory in which fixed instructions are stored. In some implementations, a basic input/output system (BIOS), containing the basic routines that help to transfer information between elements within computing system 902, such as during start-up, may typically be stored in the ROM. The RAM typically contains data and/or program modules that are presently being operated and executed by processing subsystem 910. In some implementations, system memory 960 may include multiple different types of memory, such as static random access memory (SRAM) or dynamic random access memory (DRAM). Storage subsystem 968 may be based on magnetic, optical, semiconductor, or other data storage media. Direct attached storage, storage area networks, network-attached storage, and the like may be used. Any data stores or other collections of data disclosed herein as being produced, consumed, or maintained by a service or server may be stored in storage subsystem 968.

By way of example, and not limitation, as depicted in FIG. 9, system memory 960 may store application programs 962, which may include client applications, Web browsers, mid-tier applications, relational database management systems (RDBMS), etc., program data 964, and one or more operating systems 966. By way of example, an example operating systems may include various versions of Microsoft Windows®, Apple Macintosh®, and/or Linux operating systems, a variety of commercially-available UNIX® or UNIX-like operating systems (including without limitation the variety of GNU/Linux operating systems, the Google Chrome® OS, and the like) and/or mobile operating systems such as iOS, Windows® Phone, Android® OS, BlackBerry® 10 OS, and Palm® OS operating systems.

Computer-readable storage media 952 may store programming and data constructs that provide the functionality of some embodiments. Software (programs, code modules, instructions) that when executed by processing subsystem 910 a processor provides the functionality described above may be stored in storage subsystem 968. By way of example, computer-readable storage media 952 may include non-volatile memory such as a hard disk drive, a magnetic disk drive, an optical disk drive such as a CD ROM, DVD, a Blu-Ray® disk, or other optical media. Computer-readable storage media 952 may include, but is not limited to, Zip® drives, flash memory cards, universal serial bus (USB) flash drives, secure digital (SD) cards, DVD disks, digital video tape, and the like. Computer-readable storage media 952 may also include, solid-state drives (SSD) based on non-volatile memory such as flash-memory based

SSDs, enterprise flash drives, solid state ROM, and the like, SSDs based on volatile memory such as solid state RAM, dynamic RAM, static RAM, DRAM-based SSDs, magnetoresistive RAM (MRAM) SSDs, and hybrid SSDs that use a combination of DRAM and flash memory based SSDs. Computer-readable media 952 may provide storage of computer-readable instructions, data structures, program modules, and other data for computing system 902.

In certain embodiments, storage subsystem 968 may also include a computer-readable storage media reader 950 that may further be connected to computer-readable storage media 952. Together and, optionally, in combination with system memory 960, computer-readable storage media 952 may comprehensively represent remote, local, fixed, and/or removable storage devices plus storage media for storing computer-readable information.

In certain embodiments, computing system 902 may provide support for executing one or more virtual machines. Computing system 902 may execute a program such as a hypervisor for facilitating the configuring and managing of the virtual machines. Each virtual machine may be allocated memory, compute (e.g., processors, cores), I/O, and networking resources. Each virtual machine typically runs its own operating system, which may be the same as or different from the operating systems executed by other virtual machines executed by computing system 902. Accordingly, multiple operating systems may potentially be run concurrently by computing system 902. Each virtual machine generally runs independently of the other virtual machines.

Communication subsystem 940 provides an interface to other computer systems and networks. Communication subsystem 940 serves as an interface for receiving data from and transmitting data to other systems from computing system 902. For example, communication subsystem 940 may enable computing system 902 to establish a communication channel to one or more client computing devices via the Internet for receiving and sending information from and to the client computing devices.

Communication subsystem 940 may support both wired and/or wireless communication protocols. For example, in certain embodiments, communication subsystem 940 may include radio frequency (RF) transceiver components for accessing wireless voice and/or data networks (e.g., using cellular telephone technology, advanced data network technology, such as 3G, 4G or EDGE (enhanced data rates for global evolution), WiFi (IEEE 802.11 family standards, or other mobile communication technologies, or any combination thereof), global positioning system (GPS) receiver components, and/or other components. In some embodiments communication subsystem 940 may provide wired network connectivity (e.g., Ethernet) in addition to or instead of a wireless interface.

Communication subsystem 940 may receive and transmit data in various forms. For example, in some embodiments, communication subsystem 940 may receive input communication in the form of structured and/or unstructured data feeds, event streams, event updates, and the like. For example, communication subsystem 940 may be configured to receive (or send) data feeds in real-time from users of social media networks and/or other communication services such as Twitter® feeds, Facebook® updates, web feeds such as Rich Site Summary (RSS) feeds, and/or real-time updates from one or more third party information sources.

In certain embodiments, communication subsystem 940 may be configured to receive data in the form of continuous data streams, which may include event streams of real-time events and/or event updates, that may be continuous or unbounded in nature with no explicit end. Examples of applications that generate continuous data may include, for example, sensor data applications, financial tickers, network performance measuring tools (e.g. network monitoring and traffic management applications), clickstream analysis tools, automobile traffic monitoring, and the like.

Communication subsystem 940 may also be configured to output the structured and/or unstructured data feeds, event streams, event updates, and the like to one or more databases that may be in communication with one or more streaming data source computers coupled to computing system 902.

Communication subsystem 940 may provide a communication interface 942, e.g., a WAN interface, which may provide data communication capability between the local area network (bus subsystem 970) and a larger network, such as the Internet. Conventional or other communications technologies may be used, including wired (e.g., Ethernet, IEEE 802.3 standards) and/or wireless technologies (e.g., Wi-Fi, IEEE 802.11 standards).

Computing system 902 may operate in response to requests received via communication interface 942. Further, in some embodiments, communication interface 942 may connect computing systems 902 to each other, providing scalable systems capable of managing high volumes of activity. Conventional or other techniques for managing server systems and server farms (collections of server systems that cooperate) may be used, including dynamic resource allocation and reallocation.

Computing system 902 may interact with various user-owned or user-operated devices via a wide-area network such as the Internet. An example of a user-operated device is shown in FIG. 9 as client computing system 902. Client computing system 904 may be implemented, for example, as a consumer device such as a smart phone, other mobile phone, tablet computer, wearable computing device (e.g., smart watch, eyeglasses), desktop computer, laptop computer, and so on.

For example, client computing system 904 may communicate with computing system 902 via communication interface 942. Client computing system 904 may include conventional computer components such as processing unit(s) 982, storage device 984, network interface 980, user input device 986, and user output device 988. Client computing system 904 may be a computing device implemented in a variety of form factors, such as a desktop computer, laptop computer, tablet computer, smart phone, other mobile computing device, wearable computing device, or the like.

Processing unit(s) 982 and storage device 984 may be similar to processing unit(s) 912, 914 and local storage 922, 924 described above. Suitable devices may be selected based on the demands to be placed on client computing system 904; for example, client computing system 904 may be implemented as a “thin” client with limited processing capability or as a high-powered computing device. Client computing system 904 may be provisioned with program code executable by processing unit(s) 982 to enable various interactions with computing system 902 of a message management service such as accessing messages, performing actions on messages, and other interactions described above. Some client computing systems 904 may also interact with a messaging service independently of the message management service.

Network interface 980 may provide a connection to a wide area network (e.g., the Internet) to which communication interface 940 of computing system 902 is also connected. In various embodiments, network interface 980 may include a wired interface (e.g., Ethernet) and/or a wireless interface implementing various RF data communication standards such as Wi-Fi, Bluetooth, or cellular data network standards (e.g., 3G, 2G, LTE, etc.).

User input device 986 may include any device (or devices) via which a user may provide signals to client computing system 904; client computing system 904 may interpret the signals as indicative of particular user requests or information. In various embodiments, user input device 986 may include any or all of a keyboard, touch pad, touch screen, mouse or other pointing device, scroll wheel, click wheel, dial, button, switch, keypad, microphone, and so on.

User output device 988 may include any device via which client computing system 904 may provide information to a user. For example, user output device 988 may include a display to display images generated by or delivered to client computing system 904. The display may incorporate various image generation technologies, e.g., a liquid crystal display (LCD), light-emitting diode (LED) including organic light-emitting diodes (OLED), projection system, cathode ray tube (CRT), or the like, together with supporting electronics (e.g., digital-to-analog or analog-to-digital converters, signal processors, or the like). Some embodiments may include a device such as a touchscreen that functions as both an input and output device. In some embodiments, other user output devices 988 may be provided in addition to or instead of a display. Examples include indicator lights, speakers, tactile “display” devices, printers, and so on.

Some embodiments include electronic components, such as microprocessors, storage and memory that store computer program instructions in a computer readable storage medium. Many of the features described in this specification may be implemented as processes that are specified as a set of program instructions encoded on a computer readable storage medium. When these program instructions are executed by one or more processing units, they cause the processing unit(s) to perform various operation indicated in the program instructions. Examples of program instructions or computer code include machine code, such as is produced by a compiler, and files including higher-level code that are executed by a computer, an electronic component, or a microprocessor using an interpreter. Through suitable programming, processing unit(s) 912, 914 and 982 may provide various functionality for computing system 902 and client computing system 904, including any of the functionality disclosed herein as being performed by a server or client, or other functionality associated with message management services.

It will be appreciated that computing system 902 and client computing system 904 are illustrative and that variations and modifications are possible. Computer systems used in connection with embodiments of the present disclosure may have other capabilities not specifically described here. Further, while computing system 902 and client computing system 904 are described with reference to particular blocks, it is to be understood that these blocks are defined for convenience of description and are not intended to imply a particular physical arrangement of component parts. For instance, different blocks may be, but need not be, located in the same facility, in the same server rack, or on the same motherboard. Further, the blocks need not correspond to physically distinct components. Blocks may be configured to perform various operations, e.g., by programming a processor or providing appropriate control circuitry, and various blocks might or might not be reconfigurable depending on how the initial configuration is obtained. Embodiments of the present disclosure may be realized in a variety of apparatus including electronic devices implemented using any combination of circuitry and software.

While the disclosure has been described with respect to specific embodiments, one skilled in the art will recognize that numerous modifications are possible. For instance, although specific processes are disclosed herein, other processes may be implemented. Embodiments of the disclosure may be realized using a variety of computer systems and communication technologies including but not limited to specific examples disclosed herein.

As used in the present disclosure, including the description, the appended claims and the figures, the words “first,” “second,” “third,” “fourth,” and “fifth”, etc., are adopted for convenience of description rather than limitation in order. The appearance of one or more of the words “first,” “second,” “third,” “fourth,” and “fifth”, etc., does not necessarily mean one or more of the rest must exist in the same embodiment, claims and/or figures.

Embodiments of the present disclosure may be realized using any combination of dedicated components and/or programmable processors and/or other programmable devices. The various processes disclosed herein may be implemented on the same processor or different processors in any combination. Where components are described as being configured to perform certain operations, such configuration may be accomplished, e.g., by designing electronic circuits to perform the operation, by programming programmable electronic circuits (such as microprocessors) to perform the operation, or any combination thereof. Further, while the embodiments described above may make reference to specific hardware and software components, those skilled in the art will appreciate that different combinations of hardware and/or software components may also be used and that particular operations described as being implemented in hardware might also be implemented in software or vice versa.

Computer programs incorporating various features of the present disclosure may be encoded and stored on various computer readable storage media; suitable media include magnetic disk or tape, optical storage media such as compact disk (CD) or DVD (digital versatile disk), flash memory, and other non-transitory media. Computer readable media encoded with the program code may be packaged with a compatible electronic device, or the program code may be provided separately from electronic devices (e.g., via Internet download or as a separately packaged computer-readable storage medium).

Thus, although the disclosure has been described with respect to specific embodiments, it will be appreciated that the disclosure is intended to cover all modifications and equivalents within the scope of the following claims.

What is claimed is:

1. A method comprising:
determining, based on a policy for managing scheduling of a service to be provided at an appointment location by a service provider system at an appointment time, a threshold time from the appointment time for assessing availability of a client for receiving a service;
detecting that the threshold time has been reached;
based on detecting that the threshold time has been reached, sending, to a client device associated with the client, a first request for a plurality of location determinants;
receiving a first response comprising the plurality of location determinants;
determining, based on the plurality of location determinants, a location of the client device, wherein the location is determined with respect to one or more rules indicated by the policy;
analyzing, using the location of the client device, whether the client is available at the appointment location to receive the service at the appointment time based on the one or more rules; and
sending, to the service provider system, a message indicating whether the client will be available at the appointment location to receive the service at the appointment time.

2. The method of claim 1, wherein the analyzing whether the client is available comprises:
detecting whether a threshold distance is reached by the location of the client device, wherein the threshold distance is configured based on the policy;
based on detecting that the threshold distance is not reached, sending, to the client device, a second request for confirming to receive the service; and
receiving, from the client device, a second response indicating whether the client will receive the service.

3. The method of claim 2, wherein the second response indicates that the client will be able to receive the service, the method further comprises:
determining the location of the client device is within a predetermined proximity of the appointment location for providing the service, wherein the predetermined proximity is configured based on the policy; and
checking in the client for the service.

4. The method of claim 2, wherein the second response indicates that the client will be unable to receive the service, the method further comprises:
sending, to another client device determined based on the policy, a third request to confirm to receive the service, wherein the another client device is associated with another client; and
receiving, from the another client device, a third response indicating whether the another client will receive the service.

5. The method of claim 4, further comprises:
sending, to the service provider system, a reschedule request for rescheduling the service for the client;
receiving, from the service provider system, a reschedule response, wherein the reschedule response indicates an available time for the client to receive the service;
sending, to the client device, a confirmation request for the rescheduled time; and
receiving, from the client device, a confirmation response indicating whether the client accepts the rescheduled time.

6. The method of claim 1, further comprises:
determining a threshold waiting time period according to the policy;
detecting the threshold waiting time period has been reached;
sending, to the client device, a repeat request for the plurality of location determinants; and
receiving, from the client device, a repeat response comprising an updated plurality of location determinants.

7. The method of claim 6, further comprises:
determining, based on the first response and the repeat response, that the client is moving away from the appointment location for providing the service;
sending, to the client device, a fourth request for confirming that the client will be able to receive the service;
receiving, from the client device, a fourth response indicating whether the client will be able to receive the service; and
based on the fourth response from the client indicating that the client will receive the service, checking the client in.

8. The method of claim 1, further comprises:
sending, to a traffic information system determined based on the policy, a fifth request for movement data related to movement of the client device;
receiving, from the traffic information system, a fifth response comprising the movement data; and
determining, using the plurality of the location determinants and the movement data, an estimated time of arrival of the client.

9. The method of claim 1, wherein the plurality of location determinants are selected from the group consisting one or more of: GPS coordinates of the client device; movement direction of the client device; movement rate of the client device; application usage indicating whether an application on the client device is used; network connectivity information; and calendar information on the client device.

10. The method of claim 8, wherein the movement data is selected from one or more of traffic information to assess a travel time, or average speed of traffic.

11. A resource management computer system, comprises a processor, a computer readable medium comprising instructions, executable by the processor, to:
determine, based on a policy for managing scheduling of a service to be provided at an appointment location by a service provider system at an appointment time, a threshold time from the appointment time for assessing availability of a client for receiving a service;
detect that the threshold time has been reached;
based on detecting that the threshold time has been reached, send, to a client device associated with the client, a first request for a plurality of location determinants;
receive a first response comprising the plurality of location determinants;
determine, based on the plurality of location determinants, a location of the client device, wherein the location is determined with respect to one or more rules indicated by the policy;
analyze, using the location of the client device, whether the client will be available at the appointment location to receive the service at the appointment time based on the one or more rules; and
send, to the service provider system, a message indicating whether the client will be available at the appointment location to receive the service at the appointment time.

12. The resource management computer system of claim 11, wherein the analyzing whether the client is available comprises:
detecting whether a threshold distance is reached by the location of the client device, wherein the threshold distance is configured based on the policy;
based on detecting that the threshold distance is not reached, sending, to the client device, a second request for confirming to receive the service; and
receiving, from the client device, a second response indicating whether the client will receive the service.

13. The resource management computer system of claim 12, wherein the second response indicates that the client will be able to receive the service, the processor further execute the instructions to:
determine the location of the client device is within a predetermined proximity of the appointment location for providing the service, wherein the predetermined proximity is configured based on the policy; and
check in the client for the service.

14. The resource management computer system of claim 12, wherein the second response indicates that the client will not be able to receive the service, the processor further execute the instructions to:
send, to another client device determined based on the policy, a third request to confirm to receive the service, wherein the another client device is associated with another client; and
receive, from the another client device, a third response indicating whether the another client will receive the service.

15. The resource management computer system of claim 14, wherein the processor further execute the instructions to:
send, to the service provider system, a reschedule request for rescheduling the service for the client;
receive, from the service provider system, a reschedule response, wherein the reschedule response indicates an available time for the client to receive the service;
send, to the client device, a confirmation request for the rescheduled time; and
receive, from the client device, a confirmation response indicating whether the client accepts the rescheduled time.

16. The resource management computer system of claim 11, wherein the processor further execute the instructions to:
determine a threshold waiting time period according to the policy;
detect the threshold waiting time period has been reached;
send, to the client device, a repeat request for the plurality of location determinants; and
receive, from the client device, a repeat response comprising the plurality of location determinants.

17. The resource management computer system of claim 16, wherein the processor further execute the instructions to:
determine, based on the first response and the repeat response, that the client is moving away from the appointment location for providing the service;
send, to the client device, a fourth request for confirming that the client will be able to receive the service; and
receive, from the client device, a fourth response indicating whether the client will be able to receive the service; and
based on the fourth response from the client indicating that the client will receive the service, check the client in.

18. The resource management computer system of claim 11, wherein the processor further execute the instructions to:
send, to a traffic information system determined based on the policy, a fifth request for movement data related to movement of the client device;
receive, from the traffic information system, a fifth response comprising the movement data; and
determine, using the plurality of the location determinants and the movement data, an estimated time of arrival of the client.

19. The resource management computer system of claim 11, wherein the plurality of location determinants are selected from the group consisting one or more of: GPS coordinates of the client device; movement direction of the client device; movement rate of the client device; application usage indicating whether an application on the client device is used; network connectivity information; and calendar information on the client device.

20. A service management system, comprises:
one or more service provider systems that manage or obtain access to resources for providing a service; and
a resource management computer system communicatively connected with the one or more service provider systems, wherein the resource management computer system comprises a processor, a computer readable medium comprising instructions, executable by the processor, to:
determine, based on a policy for managing scheduling of a service to be provided by the one or more service provider systems, a threshold time for assessing availability of a client for receiving a service;
detect that the threshold time has been reached;
based on detecting that the threshold time has been reached, send, to a client device associated with the client, a first request for a plurality of location determinants;
receive a first response comprising the plurality of location determinants;
determine, based on the plurality of location determinants, a location of the client device, wherein the location is determined with respect to one or more rules indicated by the policy;
analyze, using the location of the client device, whether the client is available to receive the service based on the one or more rules; and
send, to the one or more service provider systems, a message indicating whether the client is available to receive the service based on the analyzing.
